(19) United States
(12) Patent Application Publication
(10) Pub. No.: US 2025/0087743 A1
(43) Pub. Date: Mar. 13, 2025

(54) SODIUM ALL-SOLID SECONDARY BATTERY

(71) Applicant: Samsung Electronics Co., Ltd., Suwon-si (KR)

(72) Inventors: Hyunjin KIM, Suwon-si (KR); Jungock PARK, Suwon-si (KR); Youngsin PARK, Suwon-si (KR); Joungwon PARK, Suwon-si (KR); Hyunpyo LEE, Suwon-si (KR); Jonghoon KA, Suwon-si (KR)

(21) Appl. No.: 18/427,499

(22) Filed: Jan. 30, 2024

(30) Foreign Application Priority Data
Sep. 8, 2023 (KR) 10-2023-0119614

(51) Int. Cl. H01M 10/0562; H01M 4/02; H01M 4/583; H01M 4/66; H01M 10/26

(52) U.S. Cl. CPC H01M 10/0562; H01M 4/583; H01M 4/662; H01M 4/667; H01M 10/26; H01M 2004/027; H01M 2300/0071; H01M 2300/0097

(57) ABSTRACT

A sodium all-solid secondary battery including: a cathode; an anode; a sulfide-containing electrolyte between the cathode and the anode; an oxide-containing electrolyte between the sulfide-containing electrolyte and the anode; and a first bonding layer between the oxide-containing electrolyte and the sulfide-containing electrolyte, wherein the cathode includes a cathode current collector and a cathode active material layer, the anode includes an anode current collector and an anode active material layer, and the first bonding layer includes a metal capable of forming an alloy with sodium, a sodium ion-conductive material, or a combination thereof.

### CROSS-REFERENCE TO RELATED APPLICATION

This application is based on and claims priority to Korean Patent Application No. 10-2023-0119614, filed on Sep. 8, 2023, in the Korean Intellectual Property Office, and all the benefits accruing therefrom under 35 U.S.C. § 119, the content of which is incorporated by reference herein in its entirety.

### BACKGROUND

### 1. Field

The disclosure relates to a sodium all-solid secondary battery.

### 2. Description of the Related Art

Extensive research has recently been conducted on batteries providing high energy density and safety. Sodium batteries may be used in information devices, communication devices, vehicles, energy storage systems, and the like. Safety is important in vehicles, because vehicles are related to people's lives.

A liquid electrolyte-containing sodium battery includes a flammable organic solvent. Liquid electrolyte-containing sodium batteries have high risks of overheating and fire in the event of a short circuit.

On the other hand, the risks of overheating and fire of a solid electrolyte are lower than that of a liquid electrolyte. Therefore, solid electrolyte-containing sodium batteries may provide improved safety compared to liquid electrolyte-containing sodium batteries. Nonetheless, there remains a need for an improved solid electrolyte-containing sodium battery.

### SUMMARY

During a charging and discharging process of a secondary battery, interfacial resistance between a cathode and a solid electrolyte may increase. As interfacial resistance between the cathode and the solid electrolyte increases, an overvoltage of a secondary battery may increase. Defects may occur in a solid electrolyte layer during a manufacturing process and/or a charging and discharging process of a secondary battery, and cracks may be formed from the defects and grow in the solid electrolyte layer. Due to such cracks, sodium dendrite grows resulting in a short circuit. There is a need to inhibit an increase in interfacial resistance and/or occurrence of defects during a manufacturing process and/or a charging and discharging process of a secondary battery.

During a charging and discharging process of a secondary battery, sodium metal may be formed and side reactions between the sodium metal and a solid electrolyte may increase. The side reactions between the sodium metal and the solid electrolyte may increase overvoltage of the secondary battery and block dissolution of the sodium metal, thereby deteriorating a sodium all-solid secondary battery. There is a need to develop a secondary battery in which such side reactions between sodium metal and a solid electrolyte are effectively prevented during a charging and discharging process of the secondary battery.

Provided is a secondary battery having a structure that reduces interfacial resistance between a cathode and a solid electrolyte, inhibits side reactions between an anode and a solid electrolyte, and prevents occurrence of defects in the secondary battery while manufacturing and/or a charging/discharging the secondary battery.

Additional aspects will be set forth in part in the description which follows and, in part, will be apparent from the description, or may be learned by practice of the presented embodiments.

According to an aspect of the disclosure, a sodium all-solid secondary battery includes
a cathode; an anode; a sulfide-containing electrolyte between the cathode and the anode;
an oxide-containing electrolyte between the sulfide-containing electrolyte and the anode; and
a first bonding layer between the oxide-containing electrolyte and the sulfide-containing electrolyte,
wherein the cathode includes a cathode current collector and a cathode active material layer, the anode includes an anode current collector and an anode active material layer, and
the first bonding layer includes a metal capable of forming an alloy with sodium, a sodium ion-conductive material, or any combination thereof.

According to another aspect of the disclosure, a sodium all-solid secondary battery includes:
a cathode, an anode, a sulfide-containing electrolyte disposed between the cathode and the anode;
an oxide-containing electrolyte disposed between the sulfide-containing electrolyte and the anode; and
a first bonding layer disposed between the oxide-containing electrolyte and the sulfide-containing electrolyte,
wherein the cathode includes a cathode current collector and a cathode active material layer, the anode includes an anode current collector, and the first bonding layer includes a metal capable of forming an alloy with sodium, a sodium ion-conductive material, or a combination thereof.

### BRIEF DESCRIPTION OF THE DRAWINGS

The above and other aspects, features, and advantages of certain embodiments will be more apparent from the following description taken in conjunction with the accompanying drawings, in which:

FIG. 1 is a cross-sectional view of an embodiment of a sodium all-solid secondary battery;

FIG. 2 is a cross-sectional view of an embodiment of a sodium all-solid secondary battery;

FIG. 3 is a cross-sectional view of an embodiment of a sodium all-solid secondary battery;

FIG. 4 is a cross-sectional view of an embodiment of a sodium all-solid secondary battery;

FIG. 5 is a cross-sectional view of an embodiment of a sodium all-solid secondary battery;

FIG. 6 is a cross-sectional view of an embodiment of a sodium all-solid secondary battery;

FIG. 7 is a cross-sectional view of an embodiment of a sodium all-solid secondary battery;

FIG. 8 is a graph of voltage (Volts, V; none[-] indicates that there is no initial anode active material layer) vs capacity (milliampere·hours, mAh) showing results of charging and discharging profile of a first cycle and a second cycle of a sodium all-solid secondary battery of Example 1;

FIG. 9 is a graph of voltage (V) vs capacity (mAh) showing results of charging and discharging profile of a first cycle and a second cycle of a sodium all-solid secondary battery of Example 2;

FIG. 10 is a graph of voltage (V; none[-] indicates that there is no initial anode active material layer) vs capacity (mAh) showing results of charging and discharging profile of a sodium all-solid secondary battery of Comparative Example 1;

FIG. 11 is a graph of voltage (V; none[-] indicates that there is no initial anode active material layer) vs capacity (mAh) showing results of charging and discharging profile of a sodium all-solid secondary battery of Comparative Example 2;

FIG. 12 is a graph of voltage (V; none[-] indicates that there is no initial anode active material layer) vs capacity (mAh) showing results of charging and discharging profile of a sodium all-solid secondary battery of Comparative Example 3;

FIG. 13 is a graph of voltage (V; none[-] indicates that there is no initial anode active material layer) vs capacity (mAh) showing results of charging and discharging profile of a sodium all-solid secondary battery of Comparative Example 5;

FIG. 14 is a graph of voltage (V; none[-] indicates that there is no initial anode active material layer) vs capacity (mAh) showing results of charging and discharging profile of a sodium all-solid secondary battery of Comparative Example 6;

FIG. 15 is a graph of voltage (V; none[-] indicates that there is no initial anode active material layer) vs capacity (mAh) showing results of charging and discharging profile of a sodium all-solid secondary battery of Example 3;

FIG. 16 is a graph of voltage (V; none[-] indicates that there is no initial anode active material layer) vs capacity (mAh) showing results of charging and discharging profile of a sodium all-solid secondary battery of Example 4; and

FIG. 17 is a graph of voltage (V; none[-] indicates that there is no initial anode active material layer) vs capacity (mAh) showing results of charging and discharging profile of a sodium all-solid secondary battery of Reference Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” if preceding a list of elements, modify the entire list of elements and do not modify the individual elements of the list.

Various embodiments are illustrated in the accompanying drawings. The present inventive concept may, however, be embodied in many different forms and should not be construed as limited to the embodiments set forth herein. Rather, the embodiments are provided so that this disclosure will be thorough and complete, and will fully convey the scope of the present inventive concept to those skilled in the art. Like reference numerals in the drawings denote like elements.

It will be understood that if one element is referred to as being “on” another element, it may be directly on the other element, or intervening elements may also be present therebetween. If one element is referred to as being “directly on” another element, there is no intervening element therebetween.

Although the terms “first”, “second”, “third”, and the like may be used herein to describe various elements, components, regions, layers, and/or sections, these elements, components, regions, layers and/or sections should not be limited by these terms. These terms are only used to distinguish one element, component, region, layer or section from another region, layer or section. Thus, a first element, component, region, layer, or section discussed below could be termed a second element, component, region, layer or section without departing from the teachings herein.

The terms used herein is for the purpose of describing particular embodiments only and is not intended to be limiting of the present inventive concept. As used herein, an expression used in the singular may encompass the expression “at least one”, unless otherwise indicated. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. Thus, reference to “an” element in a claim followed by reference to “the” element is inclusive of one element and a plurality of the elements. The “at least one” should not be construed as singular. As used herein, the term “and/or” includes any and all combinations of one or more of the associated listed items. The terms such as “including” and/or “having” are intended to indicate the existence of features, regions, integers, processes, components, and/or elements disclosed in the specification, and are not intended to preclude the possibility that one or more other features, regions, integers, processes, components, and/or elements thereof may exist or may be added.

Spatially relative terms, such as “under”, “below”, “lower”, “on”, “above”, or “upper”, may be used herein for ease of description of the relationship of one element or feature to another element(s) or feature(s) as illustrated in the figures. It will be understood that the spatially relative terms are intended to encompass different orientations of a device in use or operation, in addition to the orientation depicted in the drawings. For example, if the device in the drawings is turned over, elements described as “below” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value. All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.).

Unless otherwise defined, all terms (including technical and scientific terms) used herein have the same meaning as commonly understood by one or ordinary skill in the art to which this application belongs. Also, it will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments will be described herein with reference to schematic cross-sectional view of ideal embodiments. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles illustrated in the drawings may be rounded. Thus, the regions illustrated in the drawings are schematic in nature and their shapes are not intended to illustrate the actual shape of a region of a device and are not intended to limit the scope of claims.

The term “Group” refers to a group of elements in the periodic table numbered from 1 to 18 classified according to a classification system of The International Union of Pure and Applied Chemistry (“IUPAC”).

In the specification, a “particle diameter” of particles indicates an average diameter of spherical particles or an average length of major axes of non-spherical particles. Particle diameters may be measured using a particle size analyzer (PSA). The “particle diameter” may be, for example, an average particle diameter. The “average particle diameter” may be, for example, a median particle diameter (D50).

D50 may refer to a particle diameter corresponding to 50% of the particles in a cumulative distribution curve measured by a laser diffraction method in which particles are accumulated in the order of particle diameter from the smallest particle to the largest particle.

D90 may refer to a particle diameter corresponding to 90% of the particles in a cumulative distribution curve measured by a laser diffraction method in which particles are accumulated in the order of particle diameter from the smallest particle to the largest particle.

D10 may refer to a particle diameter corresponding to 10% of the particles in a cumulative distribution curve measured by a laser diffraction method in which particles are accumulated in the order of particle diameter from the smallest particle to the largest particle.

In the disclosure, the term “metal” may include metals and metalloids such as silicon and germanium in an elemental or ionic state.

In the disclosure, the term “alloy” may refer to a mixture of two or more metals.

In the disclosure, the term “electrode active material” may refer to a material for electrodes allowing sodication and desodication.

In the disclosure, the term “cathode active material” may refer to a material for cathodes allowing sodication and desodication.

In the disclosure, the term “anode active material” may refer to a material for anodes allowing sodication and desodication.

In the disclosure, the terms “sodication” and “sodicating” may refer to a process of adding sodium to an electrode active material.

In the disclosure, the terms “desodication” and “desodicating” may refer to a process of removing sodium from an electrode active material.

In the disclosure, the terms “charging” and “charge” may refer to a process of supplying electrochemical energy to a battery.

In the disclosure, the terms “discharging” and “discharge” may refer to a process of removing electrochemical energy from a battery.

In the disclosure, the terms “positive electrode” and “cathode” may refer to an electrode in which electrochemical reduction and sodication occur during discharging.

In the disclosure, the terms “negative electrode” and “anode” may refer to an electrode in which electrochemical oxidation and desodication occur during discharging.

While some embodiments have been described, alternatives, modifications, variations, improvements, and substantial equivalents that are or may be presently unforeseen may arise to applicants or others skilled in the art. The appended claims as filed and as they may be amended are intended to embrace all such alternatives, modification, variations, improvements, and substantial equivalents.

Hereinafter, a sodium all-solid secondary battery according to an embodiment will be described in detail.

[Sodium all-Solid Secondary Battery]

A sodium all-solid secondary battery according to an embodiment includes: a cathode; an anode; a sulfide-containing (i.e., sulfide-based) electrolyte between the cathode and the anode; an oxide-containing (i.e., oxide-based) electrolyte between the sulfide-based electrolyte and the anode; and a first bonding layer between the oxide-based electrolyte and the sulfide-based electrolyte, wherein the cathode includes a cathode current collector and a cathode active material layer, the anode includes an anode current collector and an anode active material layer, and the first bonding layer includes a metal capable of forming an alloy with sodium, a sodium ion-conductive material, or a combination thereof.

By disposing the sulfide-based electrolyte between the cathode and the anode, an increase in interfacial resistance between the cathode and the electrolyte may be effectively inhibited during a charging and discharging process of the sodium all-solid secondary battery. An increase in overvoltage occurring during a charging and discharging process of the sodium all-solid secondary battery may be effectively inhibited.

By disposing the sulfide-based electrolyte between the cathode and the anode, defects occurring in the electrolyte during a manufacturing process and/or a charging and discharging process of the sodium all-solid secondary battery may be effectively inhibited. A short circuit and/or deterioration of lifespan characteristics of the sodium all-solid secondary battery caused by the growth of such defects may be inhibited. Cycle characteristics of the sodium all-solid secondary battery may be improved.

By disposing the oxide-based electrolyte between the anode and the sulfide-based electrolyte, side reactions occurring between sodium metal and the electrolyte during a charging and discharging process of the sodium all-solid secondary battery may be effectively inhibited. Deterioration of the sodium all-solid secondary battery caused by the side reactions between sodium metal and the sulfide-based electrolyte may be inhibited.

Cycle characteristics of the sodium all-solid secondary battery are improved.

By disposing the first bonding layer between the sulfide-based electrolyte and the oxide-based electrolyte, contact ability between the electrodes may be improved while sodium ions are transmitted between the sulfide-based electrolyte and the oxide-based electrolyte. Structural stability of the electrolyte may be improved.

By disposing the first bonding layer between the sulfide-based electrolyte and the oxide-based electrolyte, an increase in interfacial resistance between the sulfide-based electrolyte and the oxide-based electrolyte may be effectively inhibited. An increase in overvoltage occurring during a charging and discharging process of the sodium all-solid secondary battery may be effectively inhibited.

By disposing the first bonding layer between the sulfide-based electrolyte and the oxide-based electrolyte, defects occurring between the sulfide-based electrolyte and the oxide-based electrolyte during a manufacturing process and/or a charging and discharging process of the sodium all-solid secondary battery may be effectively inhibited. A short circuit and/or deterioration of lifespan characteristics of the sodium all-solid secondary battery caused by the growth of such defects may be inhibited. As a result, cycle characteristics of the sodium all-solid secondary battery are improved.

Referring to FIGS. 1 to 7, a sodium all-solid secondary battery 1 may include: a cathode 10; an anode 20; and an electrolyte 30 between the cathode 10 and the anode 20. A sulfide-based electrolyte 31 is disposed between the cathode 10 and the anode 20. The sulfide-based electrolyte 31 is arranged to be adjacent to the cathode 10. An oxide-based electrolyte 32 is disposed between the anode 20 and the sulfide-based electrolyte 31. The oxide-based electrolyte 32 is arranged to be adjacent to the anode 20. A first bonding layer 33 is disposed between the oxide-based electrolyte 32 and the sulfide-based electrolyte 31. The cathode 10 includes a cathode current collector 11 and a cathode active material layer 12. The anode 20 includes an anode current collector 21 and an anode active material layer 22. The first bonding layer 33 includes a metal capable of forming an alloy with sodium, a sodium ion-conductive material, or a combination thereof.

### [Electrolyte]

### [Electrolyte: Bonding Layer]

Referring to FIGS. 1 to 7, the electrolyte 30 includes the first bonding layer 33 disposed between the sulfide-based electrolyte 31 and the oxide-based electrolyte 32.

The first bonding layer 33 includes a metal capable of forming an alloy with sodium, a sodium ion-conductive material, or any combination thereof.

The first bonding layer 33 includes, for example, a metal capable of forming an alloy and/or compound with sodium.

By including the metal capable of forming an alloy and/or compound with sodium, the first bonding layer 33 transmits sodium between the sulfide-based electrolyte 31 and the oxide-based electrolyte 32. The first bonding layer 33 ionically connect the sulfide-based electrolyte 31 with the oxide-based electrolyte 32. The first bonding layer 33 improves contact ability between the sulfide-based electrolyte 31 and the oxide-based electrolyte 32.

The metal capable of forming an alloy and/or compound with sodium may include, for example, a first metal. The first metal includes, for example, gold (Au), tin (Sn), titanium (Ti), zinc (Zn), platinum (Pt), silicon (Si), silver (Ag), bismuth (Bi), germanium (Ge), lead (Pb), antimony (Sb), or a combination thereof. The bonding layer 33 may be, for example, a metal layer including the first metal.

The first bonding layer 33 including the metal capable of forming an alloy and/or compound with sodium may have a thickness less than a thickness of the sulfide-based electrolyte 31, the oxide-based electrolyte 32, or both. The thickness of the first bonding layer 33 may be, for example, about 50% or less, about 30% or less, about 10% or less, about or 1% or less of the thickness of the sulfide-based electrolyte 31 or the oxide-based electrolyte 32. The thickness of the first bonding layer 33 may be, for example, about 0.001% to about 50%, about 0.01% to about 30%, about 0.01% to about 10%, or about 0.01% to about 1% of the thickness of the sulfide-based electrolyte 31 or the oxide-based electrolyte 32. The thickness of the first bonding layer 33 may be, for example, about 100 nanometers (nm) or less, about 80 nm or less, about 70 nm or less, about 60 nm or less, or about 50 nm or less. The thickness of the first bonding layer 33 may be, for example, from about 1 nm to about 100 nm, from about 2 nm to about 80 nm, from about 3 nm to about 70 nm, from about 4 nm to about 60 nm, or from about 5 nm to about 50 nm. When the first bonding layer 33 has the thickness within the ranges described above, sodium ions may be easily transmitted while the sulfide-based electrolyte 31 is bonded to the oxide-based electrolyte 32. When the first bonding layer 33 is too thin, adhesion between the sulfide-based electrolyte 31 and the oxide-based electrolyte 32 may decrease. When the first bonding layer 33 is too thick, energy density of the sodium ion battery 1 may decrease.

The first bonding layer 33 may have a Mohs hardness of, for example, less than about 4, not greater than about 3.5, or not greater than about 3. The first bonding layer 33 may have a Mohs hardness of, for example, at least about 0.1 but not greater than about 4, about 0.5 to about 3.5, or about 1 to about 3. For example, the first bonding layer 33 may be a first metal layer, and the first metal layer may have a Mohs hardness of less than about 4, not greater than about 3.5, or not greater than about 3. The Mohs hardness of the first metal may be, for example, from about 0.1 but not greater than about 4, from about 0.5 to about 3.5, or from about 1 to about 3. By having the Mohs hardness within the ranges described above, the first bonding layer 33 may have improved ductility. When the Mohs hardness of the first bonding layer 33 excessively increases, brittleness of the first bonding layer 33 may increase causing cracks in the first bonding layer 33. Mohs hardness is a measure of the relative hardness and resistance to scratching between minerals (e.g., materials), with a scale ranging from 1 (softest) to 10 (hardest). In an aspect, the Mohs hardness of a material may be measured by scratching against another material with a known hardness, such as minerals from the Mohs scale as reference points.

The first bonding layer 33 includes, for example, a sodium ion-conductive material.

By including the sodium ion-conductive material, the first bonding layer 33 may ionically connect the sulfide-based electrolyte 31 with the oxide-based electrolyte 32. By including the sodium ion-conductive material, the first bonding layer 33 may improve contact ability between the sulfide-based electrolyte 31 and the oxide-based electrolyte 32.

The sodium ion-conductive material may be, for example, a solid electrolyte, a gel electrolyte, a liquid electrolyte, an ionic liquid, or any combination thereof. The solid electrolyte may be, for example, a sulfide-based solid electrolyte, an oxide-based solid electrolyte, a polymer solid electrolyte, or any combination thereof.

The sulfide-based solid electrolyte may include, for example, Na₃PS₄, Na₃₋ₓPS₄₋ₓClₓ (wherein 0<x<3), Na₃₋ₓP₁₋ₓWₓS₄ (wherein 0≤x<1), Na₃PS₄₋ₓOₓ (wherein 0<x<4), Na₃₋₂ₓCaₓPS₄ (wherein 0<x<1.5), Na₃SbS₄, Na₃₋ₓSb₁₋ₓWₓS₄ (wherein 0≤x<1), Na_{2.88}Sb_{0.88}W_{0.12}S₄₋ₓNaI (wherein 0≤x<1), Na₃WₓSiₓSb₁₋₂ₓS₄, (wherein 0≤x<0.5), Na₃₋ₓSb₁₋ₓWₓS₄₋₃ₓO₃ₓ, (wherein 0≤x<1), Na₃SbS₄−Na₂WₓS₄I₆ₓ₋₄ (wherein 0≤x<1), Na₂S—P₂S₅, Na₂S—P₂S₅—NaX (wherein X=F, Cl, Br, I, or a combination thereof), Na₂S—P₂S₅—Na₂O, Na₂S—P₂S₅—Na₂O—NaI, Na₂S—SiS₂, Na₂S—SiS₂—NaI, Na₂S—SiS₂—NaBr, Na₂S—SiS₂—NaCl, Na₂S—SiS₂—B₂S₃—NaI, Na₂S—SiS₂—P₂S₅—NaI, Na₂S—B₂S₃, Na₂S—P₂S₅—ZₘSₙ, (wherein 0<m≤10, 0<n≤10, and Z=Ge, Zn, Ga, or a combination thereof), Na₂S—GeS₂, Na₂S—SiS₂—Na₃PO₄, Na₂S—SiS₂-NaₚMO_{q} (wherein 0<p≤10, 0<q≤10, and M=P, Si, Ge, B, Al, Ga, In, or a combination thereof), Na₇₋ₓPS₆₋ₓClₓ (wherein 0≤x≤2), Na₇₋ₓPS₆₋ₓBrₓ (wherein 0≤x≤2), Na₇₋ₓPS₆₋ₓIₓ (wherein 0≤x≤2), Na₁₀MP₂S₁₂ (wherein M=Ge, Si, Sn, or a combination thereof), or a combination thereof, but is not limited thereto, and any suitable materials used in the art as sulfide-based solid electrolytes may also be used. The sulfide-based solid electrolyte may be prepared by treating a starting material such as Na₂S and P₂S₅ by melt quenching or mechanical milling. Heat treatment may be performed after such treatment. The solid electrolyte may include, for example, sulfur (S), phosphorus (P), and sodium (Na) as components among the above-described materials for the sulfide-based solid electrolyte. For example, the solid electrolyte may be a material including Na₂S—P₂S₅. In the case of using the material including Na₂S—P₂S₅ as the sulfide-based solid electrolyte material constituting the solid electrolyte, a mixing molar ratio of Na₂S to P₂S₅ may be, for example, from about 20:80 to about 90:10, from about 25:75 to about 90:10, from about 30:70 to about 70:30, or from about 40:60 to about 60:40.

The sulfide-based solid electrolyte may include, for example, an argyrodite type solid electrolyte represented by Formula a:

Na⁺₁₂₋ₙ₋ₓAⁿ⁺X²⁻₆₋ₓY⁻ₓ <Formula a>

wherein in Formula 1, A is P, As, Ge, Ga, Sb, Si, Sn, Al, In, Ti, V, Nb, or Ta, X is S, Se, or Te, and Y is Cl, Br, I, F, CN, OCN, SCN, or N₃, wherein 1≤n≤5 and 0≤x≤2. The sulfide-based solid electrolyte may be an argyrodite-type compound including, for example, Na₇₋ₓPS₆₋ₓClₓ, wherein 0≤x≤2, Na₇₋ₓPS₆₋ₓBrₓ, wherein 0≤x≤2, Na₇₋ₓPS₆₋ₓIₓ, wherein 0≤x≤2, or a combination thereof. The sulfide-based solid electrolyte may be an argyrodite-type compound including, for example, Na₆PS₅Cl, Na₆PS₅Br, Na₆PS₅I, or a combination thereof.

The argyrodite-type solid electrolyte may have a density of about 1.5 grams per cubic centimeter (g/cc) to about 2.0 g/cc. When the argyrodite-type solid electrolyte has a density of 1.5 g/cc or greater, internal resistance of the sodium all-solid secondary battery 1 may decrease and penetration of the solid electrolyte layer by Na may be effectively inhibited.

The sulfide-based solid electrolyte may be, for example, crystalline, amorphous, glassy, glass ceramic, or in a mixed state thereof. The sulfide-based solid electrolyte may have a sodium ion conductivity of, for example, about 1×10⁻⁵ Siemens per centimeter (S/cm) or greater, about 1×10⁻⁴ S/cm or greater, or about 1×10⁻³ S/cm or greater at 25° C. and 1 atm. The sodium ion conductivity may be determined, for example, by impedance measurement. When the sulfide-based solid electrolyte has the sodium ion conductivity within the ranges described above, the first bonding layer 33 may provide excellent sodium ion conductivity.

The oxide-based solid electrolyte may include, for example, NaaM1_{b}M2_{c}O_{d}, (wherein M1=Al, Y, Yb, Nd, Nb, Ti, or Hf, M2=Si or P, 1≤a≤6 1≤b≤3, 2≤c≤5, and 5≤d≤15), Na₁₊ₓZr₂SiₓP₃₋ₓO₁₂ (wherein 0≤x≤3), NaₓM₂(PO₄)₃ (wherein M=V or Ti; and 0≤x≤3), Na₃₊ₓLa_{(2/3-x)(1/3-2x)}TiO₃ (wherein 0.04<x<0.16), Na₁₊ₓAlₓTi₂₋ₓ(PO₄)₃ (wherein 0<x<2), Na₁₊ₓAlₓGe₂₋ₓ(PO₄)₃ (wherein 0<x<2), Na_{1+x+y}AlₓTi₂₋ₓSi_{y}P_{3-y}O₁₂ (wherein 0<x<2 and 0≤y<3), BaTiO₃, Pb(ZrₚTi₁₋ₚ)O₃ (wherein 0≤p≤1), Pb₁₋ₓLaₓZr_{1-y}Ti_{y}O₃ (wherein 0≤x<1 and 0≤y<1), Pb(Mg_{1/3}Nb_{2/3})O₃—PbTiO₃, Na₃PO₄, NaₓTi_{y}(PO₄)₃ (wherein 0<x<2 and 0<y<3), NaₓAl_{y}Ti_{z}(PO₄)₃ (wherein 0<x<2, 0<y<1, and 0<z<3), Na_{1+x+y}(AlₚGa₁₋ₚ)ₓ(Ti_{q}Ge_{1-q})₂₋ₓSi_{y}P_{3-y}O₁₂ (wherein 0≤x≤1, 0≤y≤1, 0≤p≤1, and 0≤q≤1), NaₓLa_{y}TiO₃ (wherein 0<x<2 and 0<y<3), Na₂O, NaOH, Na₂CO₃, NaAlO₂, Na₂O—Al₂O₃—SiO₂—P₂O₅—TiO₂—GeO₂, Na₃₊ₓLa₃M₂O₁₂ (wherein M=Te, Nb or Zr, and 1≤x≤10), Na₇La₃Zr₂O₁₂, Na₃₊ₓLa₃Zr₂₋ₐMₐO₁₂, (wherein M=Ga, W, Nb, Ta, or Al, 0<a<2, and 1≤x≤10), or any combination thereof, but is not limited thereto, and any suitable materials used in the art as oxide-based solid electrolytes may also be used. The oxide-based solid electrolyte may be, for example, a NASICON solid electrolyte represented by Na₁₊ₓZr₂SiₓP₃₋ₓO₁₂ (wherein 0≤x≤3).

The oxide-based solid electrolyte may be, for example, crystalline, amorphous, glassy, glass ceramic, or in a mixed state thereof. The oxide-based solid electrolyte may have a sodium ion conductivity of, for example, about 1×10⁻⁵ S/cm or greater, about 1×10⁻⁴ S/cm or greater, or about 1×10⁻³ S/cm or greater at 25° C. and 1 atm. The sodium ion conductivity may be determined, for example, by impedance measurement. When the oxide-based solid electrolyte has the sodium ion conductivity within the ranges described above, the bonding layer 33 may provide excellent sodium ion conductivity.

The polymer solid electrolyte may include, for example, a mixture of a sodium salt and a polymer or a polymer having an ion-conductive functional group. The polymer solid electrolyte may be, for example, a polymer electrolyte in a solid state at 25° C. and 1 atm. The polymer solid electrolyte may not include a liquid. The polymer solid electrolyte may include a polymer. The polymer may be, for example, polyethylene oxide (PEO), polyvinylidene fluoride (PVDF), polyvinylidene fluoride-hexafluoropropylene (PVDF-HFP), a poly(styrene-b-ethylene oxide) block copolymer (PS-PEO), poly(styrene-butadiene), poly(styrene-isoprene-styrene), a poly(styrene-b-divinylbenzene) block copolymer, a poly(styrene-ethylene oxide-styrene) block copolymer, polystyrene sulfonate (PSS), polyvinyl fluoride (PVF), poly(methylmethacrylate) (PMMA), polyethylene glycol (PEG), polyacrylonitrile (PAN), polytetrafluoroethylene (PTFE), polyethylenedioxythiophene (PEDOT), polypyrrole (PPY), polyacrylonitrile (PAN), polyaniline, polyacetylene, Nafion, Aquivion, Flemion, Gore, Aciplex, Morgane ADP, sulfonated poly(ether ether ketone) (SPEEK), sulfonated poly(arylene ether ketone ketone sulfone) (SPAEKKS), sulfonated poly(aryl ether ketone) (SPAEK), poly[bis(benzimidazobenzisoquinolinones)](SPBIBI), poly(styrene sulfonate) (PSS), sodium 9,10-diphenylanthracene-2-sulfonate (DPASNa+), or any combination thereof, but is not limited thereto, and any suitable compounds used in the art as polymer electrolytes may be used. The sodium salt may also be any suitable sodium salts used in the art. The sodium salt may be, for example, NaClO₄, NaPF₆, NaBF₄, NaSbF₆, NaAsF₆, NaCF₃SO₃, Na(CF₃SO₂)₂N, NaC₄F₉SO₃, NaAlO₂, NaAlCl₄, NaN(CₓF₂ₓ₊₁SO₂)(C_{y}F_{2y+1}SO₂) (wherein x and y are from 1 to 20, respectively), NaCl, NaI, sodium bis(trifluoromethane)sulfonimide (NaTFSI), sodium bis(fluorosulfonyl)imide (NaFSI), sodium difluoro(oxalato)borate (NaDFOB), sodium bis(oxalato)borate (NaBOB), or a mixture thereof. The polymer included in the polymer solid electrolyte may be, for example, a compound including about 10 or greater, about 20 or greater, about 50 or greater, or about 100 or greater repeating units. The polymer included in the polymer solid electrolyte may have a weight average molecular weight of, for example, about 1000 Dalton (Da) or greater, about 10,000 Da or greater, about 100,000 Da or greater, or about 1,000,000 Da or greater.

The polymer solid electrolyte may also serve as a binder binding the sulfide-based electrolyte 31 to the oxide-based electrolyte 32 as well as an electrolyte.

The gel electrolyte may be, for example, a polymer gel electrolyte. The gel electrolyte may have a gel state without including a polymer.

The polymer gel electrolyte may include, for example, a liquid electrolyte and a polymer, or an organic solvent and a polymer having an ion-conductive functional group. The polymer gel electrolyte may be, for example, a polymer electrolyte in a gel state at 25° C. and 1 atm. The polymer gel electrolyte may have, for example, a gel state without including a liquid. The liquid electrolyte used in the polymer gel electrolyte may be, for example, a mixture of an ionic liquid, a sodium salt, and an organic solvent; a mixture of a sodium salt and an organic solvent; a mixture of an ionic liquid and an organic solvent; or a mixture of a sodium salt, an ionic liquid, and an organic solvent. The sodium salt may be selected from the above-described sodium salts. The polymer used in the polymer gel electrolyte may be selected from polymers used in the polymer solid electrolyte. The organic solvent may be selected from organic solvents used in liquid electrolytes. The organic solvent is, for example, propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, y-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, or any mixture thereof. The sodium salt may be selected from sodium salts used in polymer solid electrolytes. The ionic liquid may refer to a salt in a liquid state at room temperature composed solely of ions and having a melting point below room temperature or a molten salt at room temperature. The ionic liquid may include, for example, at least one compound including a) a cation of ammonium, pyrrolidinium, pyridinium, pyrimidium, imidazolium, piperidinium, pyrazolium, oxazolium, pyridazinium, phosphonium, sulfonium, triazolium, or a combination thereof, and b) an anion of BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, SO₄⁻, CF₃SO₃, (FSO₂)₂N⁻, (C₂F₂SO₂)₂N⁻, (C₂F₅SO₂)(CF₃SO₂)N⁻, (CF₃SO₂)₂N⁻, or a combination thereof. The polymer solid electrolyte may be impregnated with a liquid electrolyte in a secondary battery to form a polymer gel electrolyte. The polymer gel electrolyte may further include inorganic particles.

The polymer included in the polymer gel electrolyte may be, for example, a compound including about 10 or greater, about 20 or greater, about 50 or greater, or about 100 or greater repeating units. The polymer included in the polymer gel electrolyte may have a weight average molecular weight of, for example, about 500 Da or greater, about 1000 Da or greater, about 10,000 Da or greater, about 100,000 Da or greater, or about 1,000,000 Da or greater.

The polymer gel electrolyte may also serve as a binder binding the sulfide-based electrolyte 31 to the oxide-based electrolyte 32 as well as an electrolyte. The polymer gel electrolyte may have, for example, a structure in which a porous polymer substrate is impregnated with the above-described liquid electrolyte. The porous polymer substrate may be, for example, a porous separator. Any suitable porous separators used in secondary batteries may be used. The porous separator may also serve as a binder binding the sulfide-based electrolyte 31 to the oxide-based electrolyte 32.

The liquid electrolyte may be selected from the above-described liquid electrolytes used in the gel electrolyte.

The ionic liquid may be selected from the above-described ionic liquids used in the gel electrolyte.

The first bonding layer 33 including the sodium ion-conductive material may have a thickness less than a thickness of the sulfide-based electrolyte 31 or the oxide-based electrolyte 32. The thickness of the bonding layer 33 may be, for example, about 50% or less, about 30% or less, about 10% or less, or about 1% or less of the thickness of the sulfide-based electrolyte 31 or the oxide-based electrolyte 32. The thickness of the first bonding layer 33 may be, for example, about 1% to about 50%, about 1% to about 30%, about 1% to about 10%, or about 1% to about 5% of the thickness of the sulfide-based electrolyte 31 or the oxide-based electrolyte 32. The thickness of the first bonding layer 33 may be, for example, about 100 micrometers (μm) or less, about 50 μm or less, about 30 μm or less, about 20 μm or less, or about 10 μm or less. The thickness of the first bonding layer 33 may be, for example, from about 1 μm to about 100 μm, from about 2 μm to about 50 μm, from about 3 μm to about 30 μm, from about 4 μm to about 20 μm, or from about 5 μm to about 10 μm. When the first bonding layer 33 has the thickness within the ranges described above, sodium ions may be easily transmitted via the first bonding layer 33 while the sulfide-based electrolyte 31 is bonded to the oxide-based electrolyte 32. When the first bonding layer 33 is too thin, it may be difficult to provide adhesion to the sulfide-based electrolyte 31 and the oxide-based electrolyte 32. When the first bonding layer 33 is too thick, energy density of the sodium all-solid secondary battery 1 may decrease.

### [Electrolyte: Sulfide-Based Electrolyte]

Referring to FIGS. 1 to 7, the electrolyte 30 includes the sulfide-based electrolyte 31. The sulfide-based electrolyte 31 may constitute, for example, a sulfide-based electrolyte layer.

The sulfide-based electrolyte 31 is arranged to be adjacent to the cathode 10. The sulfide-based electrolyte 31 is, for example, in contact with the cathode 10. The sulfide-based electrolyte 31 may form, for example, an interface having a low interfacial resistance to the cathode 10. The sulfide-based electrolyte 31 may have excellent wettability to the cathode 10 such that the sulfide-based electrolyte 31 has a low interfacial resistance to the cathode 10. The sulfide-based electrolyte 31 may be staked, for example, to have a wide effective contact area with the cathode 10. By arranging the sulfide-based electrolyte 31 to be adjacent to the cathode 10, an increase in internal resistance of the all-solid secondary battery 1 may be inhibited. As a result, cycle characteristics of the all-solid secondary battery may be improved. The sulfide-based electrolyte 31 may include, for example, an electrolyte identical or similar to the electrolyte included in the cathode 10.

The sulfide-based electrolyte 31 may be, for example, selected from the above-described sulfide-based solid electrolytes used in the first bonding layer 33. When the sulfide-based electrolyte 31 includes such a sulfide-based solid electrolyte, a low interfacial resistance to the cathode 10 may be maintained. Due to ductility of the sulfide-based solid electrolyte, occurrence of defects such as pores may be inhibited between the cathode 10 and the sulfide-based electrolyte 31 while the cathode 10 and the sulfide-based electrolyte 31 are stacked. While stacking the cathode 10 and the sulfide-based electrolyte 31, a wide effective contact area may be obtained between the cathode 10 and the sulfide-based electrolyte 31. The sulfide-based electrolyte 31 may effectively accommodate a volume change of the cathode 10 and/or the anode 20 occurring during a charging and discharging process of the all-solid secondary battery 1. Cycle characteristics of the all-solid secondary battery 1 may be improved because the sulfide-based electrolyte 31 adjacent to the cathode 10 includes a sulfide-based solid electrolyte.

A thickness of the sulfide-based electrolyte 31 may be, for example, from about 1 μm to about 1000 μm, from about 1 μm to about 500 μm, from about 1 μm to about 100 μm, from about 1 μm to about 50 μm, and from about 1 μm to about 30 μm, or from about 1 μm to about 10 μm. When the thickness of the sulfide-based electrolyte 31 is within the ranges described above, the sulfide-based electrolyte 31 may effectively accommodate a volume change occurring during charging and discharging of the all-solid secondary battery 1 while maintaining a low interfacial resistance to the cathode 10. When the sulfide-based electrolyte 31 is too thin, the sulfide-based electrolyte 31 may not provide sufficient ionic conductivity during high-rate charging and discharging. When the sulfide-based electrolyte 31 is too thick, energy density of the all-solid secondary battery 1 may decrease.

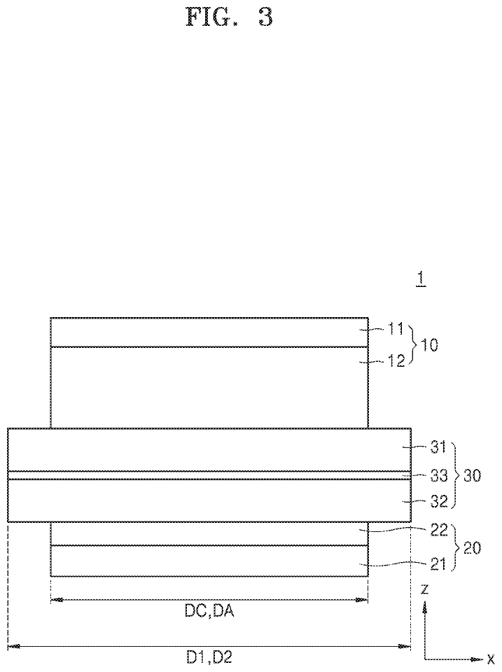

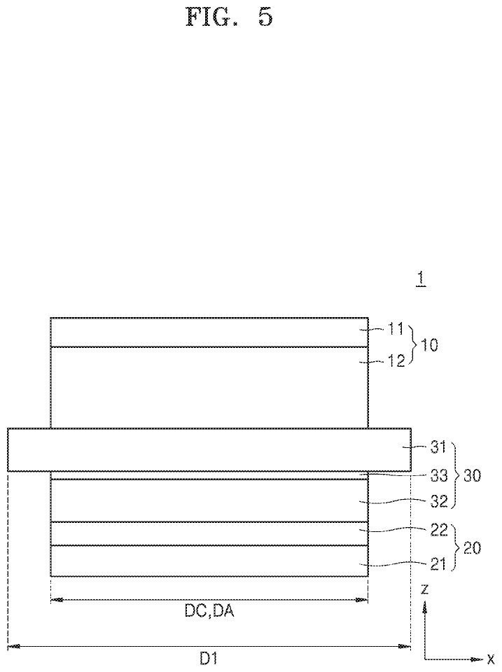

Referring to FIGS. 3 and 5, a distance D1 between both ends of a lengthwise direction (X direction of FIGS. 3 and 5) perpendicular to a thickness direction (Z direction of FIGS. 3 and 5) of the sulfide-based electrolyte 31 may be greater than a distance DC between both ends of a lengthwise direction of the cathode 10 or a distance DA between both ends of a lengthwise direction of the anode 20. The distance D1 between both ends of the lengthwise direction perpendicular to the thickness direction of the sulfide-based electrolyte 31 may be greater than the distance DC between both ends of the lengthwise direction of the cathode 10 or the distance DA between both ends of the lengthwise direction of the anode 20. The distance D1 between both ends of the lengthwise direction of the sulfide-based electrolyte 31 may be, for example, about 101% or more, about 105% or greater, about 110% or greater, about 120% or greater, or about 130% or greater than the distance DC between both ends of the lengthwise direction of the cathode 10 or the distance DA between both ends of the lengthwise direction of the anode 20. The distance D1 between both ends of the lengthwise direction of the sulfide-based electrolyte 31 may be, for example, about 101% to about 200%, about 105% to about 200%, about 110% to about 190%, about 120% to about 180%, or about 130% to about 170% of the distance DC between both ends of the lengthwise direction of the cathode 10 or the distance DA between both ends of the lengthwise direction of the anode 20. When the distance D1 between both ends of the lengthwise direction of the sulfide-based electrolyte 31 is within the ranges described above, a short circuit between the cathode 10 and the anode 20 may be effectively inhibited. Sides of the sulfide-based electrolyte 31 may have a shape protruding in the lengthwise direction perpendicular to the thickness direction compared to the sides of the cathode 10 and/or the anode 20.

### [Electrolyte: Sulfide-Based Electrolyte: Binder]

The electrolyte 30 may include, for example, a binder. The binder of the electrolyte 30 may be the same as or different from the binders included in the cathode 10 and the anode 20. The binder may be omitted.

The sulfide-based electrolyte 31 may include, for example, a binder. The binder included in the sulfide-based electrolyte 31 may be, for example, styrene butadiene rubber (SBR), polytetrafluoroethylene, polyvinylidene fluoride, or polyethylene, but is not limited thereto, and any suitable binders available in the art may also be used. An amount of the binder included in the sulfide-based electrolyte 31 may be, for example, from about 0.1 wt % to about 10 wt %, from about 0.1 to about 5 wt %, from about 0.1 to about 3 wt %, or from about 0.1 to about 1 wt %, based on a total weight of the sulfide-based electrolyte 31.

### [Electrolyte: Oxide-Based Electrolyte]

Referring to FIGS. 1 to 7, the electrolyte 30 includes the oxide-based electrolyte 32. The oxide-based electrolyte 32 may constitute, for example, an oxide-based electrolyte layer.

The oxide-based electrolyte 32 is arranged to be adjacent to the anode 20. The oxide-based electrolyte 32 is, for example, in contact with the anode 20. The oxide-based electrolyte 32 may prevent, for example, side reactions occurring between the anode 20 and the oxide-based electrolyte 32 during a charging and discharging process of the all-solid secondary battery 1. By arranging the oxide-based electrolyte 32 to be adjacent to the anode 20, side reactions may be inhibited, reversibility of electrode reactions may be improved, and rapid deterioration of the all-solid secondary battery 1 may be inhibited. Cycle characteristics of the all-solid secondary battery may deteriorate.

The oxide-based electrolyte 32 may be, for example, selected from the above-described oxide-based solid electrolytes used in the first bonding layer 33. When the oxide-based electrolyte 32 includes such an oxide-based solid electrolyte, side reactions may be inhibited between the anode 20 and the oxide-based electrolyte 32. The oxide-based solid electrolyte may not cause, for example, side reaction with sodium metal.

Since the oxide-based solid electrolyte is stable to sodium metal, deterioration of the all-solid secondary battery 1 caused by side reactions between the oxide-based electrolyte 32 and the anode 20 may be inhibited. Cycle characteristics of the all-solid secondary battery 1 may be improved because the oxide-based electrolyte 32 adjacent to the anode 20 includes an oxide-based solid electrolyte.

A thickness of the oxide-based electrolyte 32 may be, for example, from about 1 μm to about 1000 μm, from about 1 μm to about 500 μm, from about 1 μm to about 100 μm, from about 1 μm to about 50 μm, and from about 1 μm to about 30 μm, or from about 1 μm to about 10 μm. When the thickness of the oxide-based electrolyte 32 is within the ranges described above, the sulfide-based electrolyte 31 may effectively accommodate a volume change occurring during charging and discharging of the all-solid secondary battery 1 while maintaining a low interfacial resistance to the cathode 10. When the oxide-based electrolyte 32 is too thin, the oxide-based electrolyte 32 may not provide sufficient ionic conductivity during high-rate charging and discharging. When the oxide-based electrolyte 32 is too thick, energy density of the all-solid secondary battery 1 may decrease.

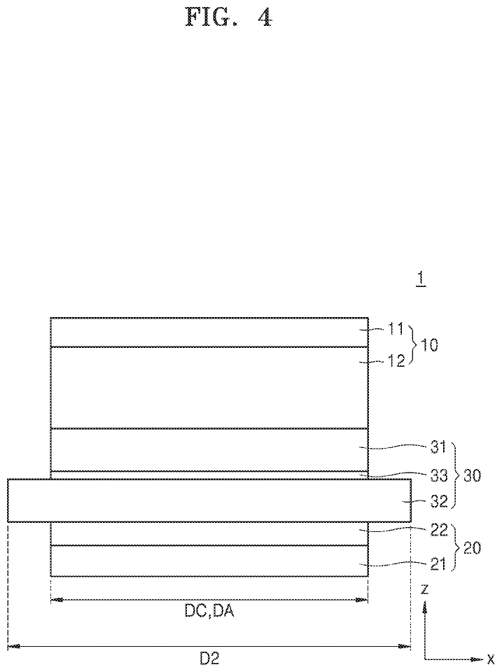

Referring to FIGS. 3 and 4, a distance D2 between both ends of a lengthwise direction (X direction of FIGS. 3 and 4) perpendicular to a thickness direction (Z direction of FIGS. 3 and 4) of the oxide-based electrolyte 32 may be greater than a distance DC between both ends of a lengthwise direction of the cathode 10 or a distance DA between both ends of a lengthwise direction of the anode 20. The distance D2 between both ends of the lengthwise direction perpendicular to the thickness direction of the oxide-based electrolyte 32 may be greater than the distance DC between both ends of the lengthwise direction of the cathode 10 or the distance DA between both ends of the lengthwise direction of the anode 20. The distance D2 between both ends of the lengthwise direction of the oxide-based electrolyte 32 may be, for example, about 101% or more, about 105% or greater, about 110% or greater, about 120% or greater, or about 130% or greater than the distance DC between both ends of the lengthwise direction of the cathode 10 or the distance DA between both ends of the lengthwise direction of the anode 20. The distance D2 between both ends of the lengthwise direction of the oxide-based electrolyte 32 may be, for example, about 101% to about 200%, about 105% to about 200%, about 110% to about 190%, about 120% to about 180%, or about 130% to about 170% of the distance DC between both ends of the lengthwise direction of the cathode 10 or the distance DA between both ends of the lengthwise direction of the anode 20. When the distance D2 between both ends of the lengthwise direction of the oxide-based electrolyte 32 is within the ranges described above, a short circuit between the cathode 10 and the anode 20 may be effectively inhibited. Sides of the oxide-based electrolyte 32 may have a shape protruding in the lengthwise direction perpendicular to the thickness direction compared to the sides of the cathode 10 and/or the anode 20.

### [Electrolyte: Oxide-Based Electrolyte: Binder]

The oxide-based electrolyte 32 may include, for example, a binder. The binder included in the oxide-based electrolyte 32 may be selected from the binders used in the sulfide-based electrolyte 31. The binder may be omitted.

An amount of the binder included in the oxide-based electrolyte layer 32 may be from about 0 wt % to about 10 wt %, from about 0 wt % to about 5 wt %, from about 0 wt % to about 3 wt %, from about 0 wt % to about 1 wt %, from about 0 wt % to about 0.5 wt %, or from about 0 wt % to 0.1 wt %, based on a total weight of the oxide-based electrolyte 32.

Alternatively, the oxide-based electrolyte 32 may not include a binder. For example, the oxide-based solid electrolyte obtained by heating at a high temperature may not include a binder because the binder is thermally decomposed during the manufacturing process.

### [Cathode]

### [Cathode: Cathode Active Material]

Referring to FIGS. 1 to 7, the cathode active material layer 12 include, for example, a cathode active material.

The cathode active material may be a sodium transition metal oxide, a polyanionic compound, a Prussian blue compound, or a combination thereof.

In the sodium transition metal oxide, the transition metal may include, for example, Mn, Fe, Ni, Co, Cr, Cu, Ti, Zn, V, Zr, Ce, or a combination thereof. The sodium transition metal oxide may be, for example, a compound including sodium, a transition metal, and an oxygen unit. An amount of sodium may be greater than 0 but not greater than about 1 mole, and an amount of the transition metal may be about 1 mole per 1 mole of the sodium transition metal oxide. The transition metal M may include Ti, V, Mn, Co, Ni, Fe, Cr, Cu, or a combination thereof, and an amount of oxygen (O) is about 2 mole per 1 mole of the sodium transition metal oxide.

The polyanionic compound may be, for example, a compound including sodium, a transition metal, and a tetrahedral (YO₄)ⁿ⁻ anion unit. The transition metal may include, for example, Mn, Fe, Ni, Co, Cr, Cu, Ti, Zn, V, Zr, Ce, or a combination thereof. Y may include, for example, P, S, Si, or a combination thereof. N indicates a valence state of (YO₄)ⁿ⁻ and may be, for example, from 1 to 5.

The polyanionic compound may be, for example, a compound including sodium, a transition metal, a tetrahedral (YO₄)ⁿ⁻ anion unit, and a halogen. The transition metal may include, for example, Mn, Fe, Ni, Co, Cr, Cu, Ti, Zn, V, Zr, Ce, or a combination thereof. Y may include, for example, P, S, Si, or a combination thereof. N indicates a valence state of (YO₄)ⁿ⁻ and may be, for example, from 1 to 5. The halogen includes, for example, F, Cl, Br, or a combination thereof.

The polyanionic compound may be, for example, a compound including sodium, a tetrahedral (YO₄)ⁿ⁻ anion unit, a polyhedral (ZO_{y})^{m+} unit, and a selective halogen. Y may include, for example, P, S, Si, or a combination thereof. N indicates a valence state of (YO₄)ⁿ⁻ and may be, for example, from 1 to 5. Z may be a transition metal including, for example, Mn, Fe, Ni, Co, Cr, Cu, Ti, Zn, V, Zr, Ce, or a combination thereof. M indicates a valence state of (ZO_{y})^{m+} and may be, for example, from 1 to 5. The halogen includes, for example, F, Cl, Br, or a combination thereof.

The polyanionic compound may include, for example, NaFePO₄, Na₃V₂(PO₄)₃, NaM′PO₄F (wherein M′=V, Fe, Mn, Ni, or a combination thereof), Na₃(VO_{y})₂(PO₄)₂F_{3-2y} (wherein 0≤y<1), or a combination thereof.

The Prussian blue compound and/or its analogue may be, for example, a compound including sodium, a transition metal, and a cyanide unit (CN−). The transition metal may include, for example, Mn, Fe, Ni, Co, Cr, Cu, Ti, Zn, V, Zr, Ce, or a combination thereof. The Prussian blue compound and/or its analogue herein may refer to a family of coordination compounds assembled from octahedrally coordinated cyanide bridging transition metal nodes with a parent structure such as M[M′(CN)6](M and M′ are transition metals) and variation of metal choices and their oxidation state, and incorporation of sodium allows alteration of the vacancies content via the hexacyanometallates withdrawal to compensate for the electroneutrality.

The Prussian blue compound and/or its analogue may be, for example, a compound including sodium, a first transition metal, a second transition metal, and a cyanide unit. An amount of sodium may be greater than 0 but not greater than about 2 mole, amounts of the first transition metal and the second transition metal each independently may be greater than 0 but less than about 1 mole, the first transition metal and the second transition metal may be each independently Ni, Cu, Fe, Mn, Co, Zn, or a combination thereof, and an amount of the cyanide unit may be about 6 mole per 1 mole of the Prussian blue compound.

The above-described compound having a coating layer on the surface thereof may also be used or a mixture of the above-described compound and a compound having a coating layer may also be used. The coating layer added to the surface of the compound may include, for example, a compound of a coating element such as an oxide, hydroxide, oxyhydroxide, oxycarbonate, or hydroxycarbonate of the coating element. The compound of the coating layer may be amorphous or crystalline. The coating element included in the coating layer may be Mg, Al, Co, K, Na, Ca, Si, Ti, V, Sn, Ge, Ga, B, As, Zr, or any mixture thereof. A method of forming the coating layer may be selected from those not adversely affecting physical properties of the cathode active material. The coating methods may be, for example, spray coating and dip coating. These methods may be obvious to those of ordinary skill in the art, and thus detailed descriptions thereof will not be given.

The cathode active material may be, for example, a polyanionic compound represented by Formulae 1 to 5, a layered sodium transition metal oxide represented by Formulae 6 and 7, a Prussian blue compound represented by Formula 8, or a combination thereof.

NaM1(XO₄) <Formula 1>

wherein in Formula 1,
M1 is manganese (Mn), iron (Fe), nickel (Ni), cobalt (Co), chromium (Cr), copper (Cu), titanium (Ti), zinc (Zn), vanadium (V), zirconium (Zr), cerium (Ce), or any combination thereof, and
X is phosphorus (P), sulfur (S), silicon (Si), or any combination thereof.

NaₓM2_{y}(XO₄)₃ <Formula 2>
wherein in Formula 2,
0<x≤3, 0<y≤2,
M2 is manganese (Mn), iron (Fe), nickel (Ni), cobalt (Co), chromium (Cr), copper (Cu), titanium (Ti), zinc (Zn), vanadium (V), zirconium (Zr), cerium (Ce), or any combination thereof, and
X is phosphorus (P), sulfur (S), silicon (Si), or any combination thereof.

NaₓM3_{y}(XO₄)Z_{z} <Formula 3>
wherein in Formula 3,
0<x≤3, 0<y≤2, 0<z≤1,
M3 is manganese (Mn), iron (Fe), nickel (Ni), cobalt (Co), chromium (Cr), copper (Cu), titanium (Ti), zinc (Zn), vanadium (V), zirconium (Zr), cerium (Ce), or any combination thereof,
X is phosphorus (P), sulfur (S), silicon (Si), or any combination thereof, and
Z is F, Cl, Br, I, or a combination thereof.

Naₓ(M4Oₐ)_{y}(XO₄)_{z}Zᵥ <Formula 4>
wherein in Formula 4,
0<x≤3, 0<y≤2, 0<z≤2, 0<v≤1, 0<a≤5,
M4 is manganese (Mn), iron (Fe), nickel (Ni), cobalt (Co), chromium (Cr), copper (Cu), titanium (Ti), zinc (Zn), vanadium (V), zirconium (Zr), cerium (Ce), or any combination thereof,
X is phosphorus (P), sulfur (S), silicon (Si), or any combination thereof, and
Z is F, Cl, Br, I, or a combination thereof.

NaₓM5_{y}(XO₄)_{z}(Z₂O₇)ᵥ <Formula 5>
wherein in Formula 5,
0<x≤4, 0<y≤3, 0≤z≤3, 0≤v<2,
M5 is manganese (Mn), iron (Fe), nickel (Ni), cobalt (Co), chromium (Cr), copper (Cu), titanium (Ti), zinc (Zn), vanadium (V), zirconium (Zr), cerium (Ce), or any combination thereof, and
X and Z are each independently phosphorus (P), sulfur (S), silicon (Si), or any combination thereof.

NaₓM6O₂ <Formula 6>
wherein in Formula 6,
0<x≤1, and
M6 is titanium (Ti), vanadium (V), manganese (Mn), cobalt (Co), nickel (Ni), iron (Fe), chromium (Cr), copper (Cu), or any combination thereof.

NaₐNi_{b}M7_{c}M8_{d}M9ₑM10_{f}O₂
wherein in Formula 7,
0.4≤a<1, 0<b<0.5, 0≤c<1, 0≤d<0.5, 0≤e<0.5, 0≤f<0.5, 0<c+e<1.5,
M7 is manganese (Mn), titanium (Ti), zirconium (Zr), or any combination thereof,
M8 is magnesium (Mg), calcium (Ca), copper (Cu), zinc (Zn), cobalt (Co), or any combination thereof,
M9 is manganese (Mn), titanium (Ti), zirconium (Zr), or any combination thereof, and
M10 is aluminum (Al), iron (Fe), cobalt (Co), molybdenum (Mo), chromium (Cr), vanadium (V), scandium (Sc), yttrium (Y), or any combination thereof.

NaₓM11_{y}M12_{z}(CN)₆ <Formula 8>
wherein in Formula 8,0<x≤2, 0<y≤1, 0<z≤1, and
M11 and M12 are each independently manganese (Mn), nickel (Ni), copper (Cu), cobalt (Co), iron (Fe), zinc (Zn), vanadium (V), chromium (Cr), or any combination thereof.

An amount of the cathode active material included in the cathode active material layer 12 may be, for example, from about 30 wt % to about 95 wt %, from about 40 wt % to about 90 wt %, from about 50 wt % to about 80 wt %, or from about 50 wt % to about 70 wt %, based on a total weight of the cathode active material layer 12.

When the amount of the cathode active material is too low, energy density of the all-solid secondary battery 1 may decrease.

### [Cathode: Electrolyte]

The cathode active material layer 12 may further include, for example, an electrolyte. The electrolyte may be, for example, a sulfide-based solid electrolyte. The sulfide-based solid electrolyte included in the cathode 10 may be identical to or different from the sulfide-based solid electrolytes included in the first bonding layer 33, the sulfide-based electrolyte 31, and the oxide-based electrolyte 32. For detailed descriptions of the sulfide-based solid electrolyte, refer to the first bonding layer 33, the sulfide-based electrolyte 31, and/or the oxide-based electrolyte 32.

The electrolyte included in the cathode active material layer 12 may have an average particle diameter D50 less than that of an electrolyte included in the electrolyte 30. For example, the average particle diameter D50 of the electrolyte included in the cathode active material layer 12 may be about 90% or less, about 80% or less, about 70% or less, about 60% or less, about 50% or less, about 40% or less, about 30% or less, or about 20% or less of the average particle diameter D50 of the electrolyte included in the electrolyte 30. The average particle diameter D50 may be, for example, a median particle diameter D50. The median particle diameter D50 may be a particle diameter corresponding to a 50% cumulative volume from the smallest particle diameter calculated from the smallest particle in a particle size distribution measured, for example, by a laser diffraction method.

An amount of the electrolyte included in the cathode active material layer 12 may be, for example, from about 1 wt % to about 40 wt %, from about 5 wt % to about 40 wt %, from about 10 wt % to about 40 wt %, or from about 20 wt % to about 40 wt % based on the total weight of the cathode active material layer 12.

### [Cathode: Conductive Material]

The cathode active material layer 12 may further include a conductive material. The conductive material may be, for example, a carbonaceous conductive material, a metallic conductive material, or any combination thereof. The carbonaceous conductive material may be, for example, graphite, carbon black, acetylene black, Ketjen black, carbon fiber, or any combination thereof, but is not limited thereto, and any suitable carbonaceous conductive materials available in the art may also be used. The metallic conductive material may be metal powder, metal fiber, or any combination thereof, but is not limited thereto, and any suitable metallic conductive materials available in the art may also be used. An amount of the conductive material included in the cathode active material layer 12 may be, for example, from about 1 wt % to about 30 wt %, from about 1 wt % to about 20 wt %, or from about 1 wt % to about 10 wt % based on the total weight of the cathode active material layer 12. The conductive material may be omitted.

### [Cathode: Binder]

The cathode active material layer 12 may further include a binder. The binder may be styrene butadiene rubber (SBR), polytetrafluoroethylene, polyvinylidene fluoride, or polyethylene, but is not limited thereto, and any suitable binders available in the art may also be used. An amount of the binder included in the cathode active material layer 12 may be, for example, from about 1 wt % to about 10 wt % or from about 1 wt % to about 5 wt % based on the total weight of the cathode active material layer 12. The binder may be omitted.

### [Cathode: Other Additives]

The cathode active material layer 12 may further include additives such as a filler, a coating agent, a dispersant, and an ion-conductive adjuvant in addition to the cathode active material, the solid electrolyte, the binder, and the conductive material described above.

Any suitable known materials used in electrodes of sodium all-solid secondary batteries 1 may be used for the filler, the coating agent, the dispersant, and the ion-conductive adjuvant included in the cathode active material layer 12.

### [Cathode: Cathode Current Collector]

The cathode current collector 11 may be, for example, in the form of a plate or foil formed of indium (In), copper (Cu), magnesium (Mg), stainless steel, titanium (Ti), iron (Fe), cobalt (Co), nickel (Ni), zinc (Zn), aluminum (Al), germanium (Ge), sodium (Na), or an alloy thereof, or a combination thereof. The cathode current collector 11 may be omitted. The cathode current collector 11 may have a thickness of, for example, about 1 μm to about 100 μm, about 1 μm to about 50 μm, about 5 μm to about 25 μm, or about 10 μm to about 20 μm.

The cathode current collector 11 may include, for example, a base film and a metal layer disposed on one or both sides of the base film. The base film may include, for example, a polymer. The polymer may include, for example, polyethyleneterephthalate (PET), polyethylene (PE), polypropylene (PP), polybutyleneterephthalate (PBT), polyimide (PI), or any combination thereof. The metal layer may include, for example, indium (In), copper (Cu), magnesium (Mg), stainless steel, titanium (Ti), iron (Fe), cobalt (Co), nickel (Ni), zinc (Zn), aluminum (Al), germanium (Ge), sodium (Na), or an alloy thereof, or a combination thereof. When the cathode current collector 11 has the above-described structure, the weight of the electrode may be reduced, so as to increase energy density of the sodium all-solid secondary battery 1.

### [Cathode: Bonding Layer]

Although not shown in the drawings, a second bonding layer may further be disposed between the cathode 10 and the sulfide-based electrolyte 31. For detailed descriptions of the bonding layer, refer to the above-described first bonding layer 33 of the electrolyte 30. In an aspect, the second bonding layer may comprise a second metal, and the second metal may comprise, gold, tin, titanium, zinc, platinum, silicon, silver, bismuth, germanium, lead, antimony, or a combination thereof.

By including the second bonding layer between the cathode 10 and the sulfide-based electrolyte 31, sodium ions may be transmitted between the cathode 10 and the sulfide-based electrolyte 31 and the contact ability between the cathode 10 and the sulfide-based electrolyte 31 may be improved.

### [Anode I: Plated Anode]

Referring to FIGS. 1 to 6, the anode 20 may be a plated anode 20. In an all-solid secondary battery 1 including the plated anode 20, a sodium metal layer may further be plated between the anode active material layer 22 and the anode current collector 21 by charging. A sodium source of the anode 20 may be omitted in the all-solid secondary battery 1 including the plated anode 20, and thus energy density of the all-solid secondary battery 1 may further be increased.

### [Anode I: Anode Active Material]

Referring to FIGS. 1 to 5, the anode 20 may include an anode active material layer 22. The anode active material layer 22 may include, for example, an anode active material and a binder.

The anode active material may include, for example, a carbonaceous anode active material, a metallic anode active material, or a combination thereof.

The carbonaceous anode active material may include, for example amorphous carbon, crystalline carbon, porous carbon, or a combination thereof.

The carbonaceous anode active material may be, for example, amorphous carbon. The amorphous carbon may be, for example, carbon black (CB), acetylene black (AB), furnace black (FB), Ketjen black (KB), or graphene, but is not limited thereto, and any suitable carbon classified as amorphous carbon in the art may also be used. Amorphous carbon may be carbon that does not have crystallinity or has very low crystallinity and may be distinguished from crystalline carbon or graphite-containing (i.e., -based) carbon.

The carbonaceous anode active material may be, for example, porous carbon. A volume of pores in the porous carbon may be, for example, from about 0.1 cc/g to about 10.0 cc/g, from about 0.5 cc/g to about 5 cc/g, or from about 0.1 cc/g to about 1 cc/g. The porous carbon may have an average pore diameter of, for example, about 1 nm to about 50 nm, about 1 nm to about 30 nm, or about 1 nm to about 10 nm. The porous carbon may have a BET specific surface area of, for example, about 100 square meters per gram (m²/g) to about 3000 m²/g.

The metallic anode active material may include gold (Au), tin (Sn), titanium (Ti), zinc (Zn), platinum (Pt), palladium (Pd), silicon (Si), silver (Ag), aluminum (Al), bismuth (Bi), germanium (Ge), lead (Pb), antimony (Sb), or a combination thereof, but is not limited thereto, and any suitable materials used in the art as a metallic anode active material forming an alloy or compound with sodium may also be used. For example, nickel (Ni) may not be a metallic anode active material, because Ni does not form an alloy with sodium.

The anode active material layer 22 may include one type of the anode active materials or a mixture of a plurality of different anode active materials among these anode active materials. For example, the anode active material layer 22 may include only amorphous carbon or may include gold (Au), tin (Sn), titanium (Ti), zinc (Zn), platinum (Pt), silicon (Si), silver (Ag), or any combination thereof. Alternatively, the anode active material layer 22 may include a mixture of amorphous carbon and gold (Au), tin (Sn), titanium (Ti), zinc (Zn), platinum (Pt), silicon (Si), silver (Ag), or any combination thereof. A mixing ratio of amorphous carbon and gold, or the like, in the mixture may be, for example, from about 99:1 to about 1:99, from about 10:1 to about 1:2, from about 5:1 to about 1:1, or from about 4:1 to about 2:1. However, the mixing ratio is not limited thereto but may be selected in accordance with desired characteristics of the sodium all-solid secondary battery 1. Due to the composition of the anode active material, cycle characteristics of the sodium all-solid secondary battery 1 may further be improved.

The anode active material layer 22 includes the anode active material, and the anode active material includes, for example, a mixture of a first particle comprising amorphous carbon and a second particle comprising a metal or metalloid. The metal includes, for example, gold (Au), tin (Sn), titanium (Ti), zinc (Zn), platinum (Pt), palladium (Pd), silicon (Si), silver (Ag), aluminum (Al), bismuth (Bi), germanium (Ge), lead (Pb), or antimony (Sb). An amount of the second particles may be from about 1 to about 99 wt %, from about 1 wt % to about 60 wt %, from about 8 wt % to about 60 wt %, from about 10 wt % to about 50 wt %, from about 15 wt % to about 40 wt %, or from about 20 wt % to about 30 wt %, based on a total weight of the mixture. When the amount of the second particles is within the ranges above, cycle characteristics of the sodium all-solid secondary battery 1 may further be improved.

The anode active material may be, for example, in the form of a particle. The anode active material in the form of a particle may have an average particle diameter of, for example, about 4 μm or less, about 3 μm or less, about 2 μm or less, about 1 μm or less, about 500 nm or less, about 300 nm or less, or about 100 nm or less. The anode active material in the form of particles may have an average particle diameter of, for example, about 10 nm to about 4 μm, about 10 nm to about 3 μm, about 10 nm to about 2 μm, about 10 nm to about 1 μm, about 10 nm to about 500 nm, about 10 nm to about 300 nm, or about 10 nm to about 100 nm. When the average particle diameter of the anode active material is within the ranges described above, reversible absorbing and/or desorbing of sodium may occur more easily during charging and discharging. The average particle diameter of the anode active material may be, for example, a median diameter D50 measured using a laser particle size analyzer.

### [Anode I: Binder]

The binder included in the anode active material layer 22 may be, for example, styrene butadiene rubber (SBR), polytetrafluoroethylene, polyvinylidene fluoride, polyethylene, a vinylidene fluoride/hexafluoropropylene copolymer, polyacrylonitrile, or polymethylmethacrylate, but is not limited thereto, and any suitable binders available in the art may also be used. The binder may be used alone or as a combination of a plurality of different binders.

The anode active material layer 22 may be stabilized on the anode current collector 21, because the anode active material layer 22 includes the binder. Also, cracks may be inhibited in the anode active material layer 22 during a charging and discharging process, although a volume and/or a relative position of the anode active material layer 22 changes. For example, if the anode active material layer 22 does not include a binder, the anode active material layer 22 may be easily separated from the anode current collector 21. When the anode active material layer 22 is separated from the anode current collector 21, an exposed region of the anode current collector 21 is brought into contact with the solid electrolyte 30, thereby increasing the possibility of occurrence of a short circuit. The anode active material layer 22 may be prepared by, for example, applying a slurry, in which materials of the anode active material layer 22 are dispersed, to the anode current collector 21, and drying the slurry. By adding the binder to the anode active material layer 22, the anode active material may be stably dispersed in the slurry. For example, in the case of applying the slurry to the anode current collector 21 by screen printing, it may be possible to inhibit clogging of a screen (e.g., clogging by agglomerates of the anode active material).

### [Anode I: Other Additives]

The anode active material layer 22 may further include additives used in conventional sodium all-solid secondary batteries 1, such as a filler, a coating agent, a dispersant, and an ion-conductive adjuvant.

### [Anode I: Anode Active Material Layer]

Referring to FIGS. 1 to 5, a ratio B/A of an initial charge capacity B of the anode active material layer 22 to an initial charge capacity A of the cathode active material layer may be, for example, less than about 1, about 0.8 or less, about 0.6 or less, about 0.45 or less, about 0.4 or less, about 0.3 or less, about 0.2 or less, or about 0.1 or less. The initial charging capacity of the cathode active material layer 12 may be determined at a maximum charging voltage relative to Na/Na⁺ from a 1^{st} open circuit voltage. The initial charge capacity of the anode active material layer 22 is determined at 0.01 V relative to Na/Na⁺ from a 2^{nd} open circuit voltage. The maximum charging voltage may be determined by a type of the cathode active material. The maximum charging voltage may be, for example, about 1.5 V, about 2.0 V, about 2.5 V, about 3.0 V, about 3.5 V, about 4.0 V, about 4.2 V, or about 4.3 V. The ratio B/A of the initial charge capacity B of the anode active material layer 22 to the initial charge capacity A of the cathode active material layer may be, for example, from about 0.01 to about 0.5, from about 0.01 to about 0.4, from about 0.01 to about 0.3, from about 0.01 to about 0.2, or from about 0.05 to about 0.1.

The initial charge capacity (mAh) of the cathode active material layer 12 may be obtained by multiplying a specific charge capacity (mAh/g) of the cathode active material by a mass (g) of the cathode active material in the cathode active material layer 12. When various types of the cathode active material are used, specific charge capacityxmass values for all of the cathode active materials are calculated respectively, and a sum of the values may be regarded as an initial charge capacity of the cathode active material layer 12. The initial charge capacity of the anode active material layer 22 is calculated in the same manner. The initial charging capacity of the anode active material layer 22 may be obtained by multiplying a specific charge capacity (mAh/g) of the anode active material by a mass of the anode active material of the anode active material layer 22. When various types of anode active materials are used, specific charge capacityxmass values for all of the anode active materials are calculated respectively, and a sum of the values may be regarded as the initial charge capacity of the anode active material layer 22. The specific charge capacity of the cathode active material and the anode active material may be measured using an all-solid half-cell to which sodium metal is used as a counter electrode. The initial charge capacities of the cathode active material layer 12 and the anode active material layer 22 may be directly measured respectively at a constant current density of, e.g., 0.1 milliampere per square centimeter (mA/cm²), using an all-solid half-cell. The measurement may be performed on the cathode by charging from the 1^{st} open circuit voltage (OCV) to the maximum charging voltage, e.g., 3.0 V (vs. Li/Li⁺). The measurement may be performed on the anode, e.g., sodium metal, by charging from the 2^{nd} open circuit voltage (OCV) to 0.01 V. For example, an all-solid half-cell including the cathode active material layer may be charged at a constant current of 0.1 mA/cm² from the 1^{st} open circuit voltage to 3.0 V, and the all-solid half-cell including the anode active material layer may be charged at a constant current of 0.1 mA/cm² from the 2^{nd} open circuit voltage to 0.01 V. A current density during the charging at the constant current may be, for example, 0.2 mA/cm² or 0.5 mA/cm². An all-solid half-cell including the cathode active material layer may be charged, for example, from the 1^{st} open circuit voltage to about 2.5 V, about 2.0 V, about 3.5 V, or about 4.0 V. The maximum charging voltage of the cathode active material may be determined by a maximum voltage of a battery satisfying safety conditions according to JISC8712:2015 of the Japanese Standards Association.

When the anode active material layer 22 has a too low initial charge capacity, the thickness of the anode active material layer 22 may become too thin, and thus sodium dendrite formed between the anode active material layer 22 and the anode current collector 21 during repeated charging and discharging processes may break the anode active material layer 22, making it difficult to improve cycle characteristics of the sodium all-solid secondary battery 1. When the charge capacity of the anode active material layer 22 is too high, energy density of the sodium all-solid secondary battery 1 may decrease, and thus internal resistance of the sodium all-solid secondary battery 1 may be increased by the anode active material layer 22, making it difficult to improve cycle characteristics of the sodium all-solid secondary battery 1.

A thickness of the anode active material layer 22 may be, for example, about 50% or less, about 40% or less, about 30% or less, about 20% or less, about 10% or less, or about 5% or less of a thickness of the cathode active material layer 12. The thickness of the anode active material layer 22 may be, for example, from about 1% to about 50%, from about 1% to about 40%, from about 1% to about 30%, from about 1% to about 20%, from about 1% to about 10%, or from about 1% to about 5% of the thickness of the cathode active material layer 12. The thickness of the anode active material layer 22 may be, for example, from about 1 μm to about 20 μm, from about 2 μm to about 15 μm, or from about 3 μm to about 10 μm. When the anode active material layer 22 is too thin, sodium dendrite formed between the anode active material layer 22 and the anode current collector 21 may break the anode active material layer 22, making it difficult to improve cycle characteristics of the sodium all-solid secondary battery 1. When the anode active material layer 22 is too thick, energy density of the sodium all-solid secondary battery 1 may decrease, and thus internal resistance of the sodium all-solid secondary battery 1 may be increased by the anode active material layer 22, making it difficult to improve cycle characteristics of the sodium all-solid secondary battery 1. As the thickness of the anode active material layer 22 decreases, for example, an initial charge capacity of the anode active material layer 22 may also decrease.

The anode active material layer 22 may have a greater thickness than that of the first bonding layer 33. The thickness of the first bonding layer 33 may be, for example, about 50% or less, about 40% or less, about 30% or less, about 20% or less, about 10% or less, about 5% or less, or about 1% or less of the thickness of the anode active material layer 22. The thickness of the first bonding layer 33 including a metal capable of forming an alloy with sodium may be from about 0.01% to about 10%, about 0.01% to about 5%, about 0.01% to about 1%, or about 0.01% to about 0.1% of a thickness of the anode active material layer 22. The thickness of the first bonding layer 33 including a sodium ion-conductive material may be about 1% to about 50%, about 1% to about 40%, about 1% to about 30%, about 1% to about 20%, or about 1% to about 10% of the thickness of the anode active material layer 22.

### [Anode I: Bonding Layer]

Although not shown in the drawings, the sodium all-solid secondary battery 1 may further include a third bonding layer between the anode 20 and the oxide-based electrolyte 32. The third bonding layer may further include a metal capable of forming an alloy with sodium or an alloy of the metal and sodium. The metal capable of forming an alloy with sodium may include, for example, a third metal. The third metal includes, for example, gold (Au), tin (Sn), titanium (Ti), zinc (Zn), platinum (Pt), silicon (Si), silver (Ag), bismuth (Bi), germanium (Ge), lead (Pb), antimony (Sb), or y combination thereof. When the third bonding layer includes the third metal, cycle characteristics of the sodium all-solid secondary battery 1 may further be improved.

A thickness of the third bonding layer may be, for example, about 100 nm or less, about 80 nm or less, about 70 nm or less, about 60 nm or less, or about 50 nm or less. The thickness of the third bonding layer may be, for example, from about 1 nm to about 100 nm, from about 2 nm to about 80 nm, from about 3 nm to about 70 nm, from about 4 nm to about 60 nm, or from about 5 nm to about 50 nm. Cycle characteristics of the all-solid secondary battery 1 may further be improved when the thickness of the third bonding layer is within the range described above. When the third bonding layer is too thin, effects as an anode active material layer may not be provided. When the third bonding layer is too thick, internal resistance may increase to deteriorate cycle characteristics of the all-solid secondary battery 1.

### [Anode I: Metal Layer]

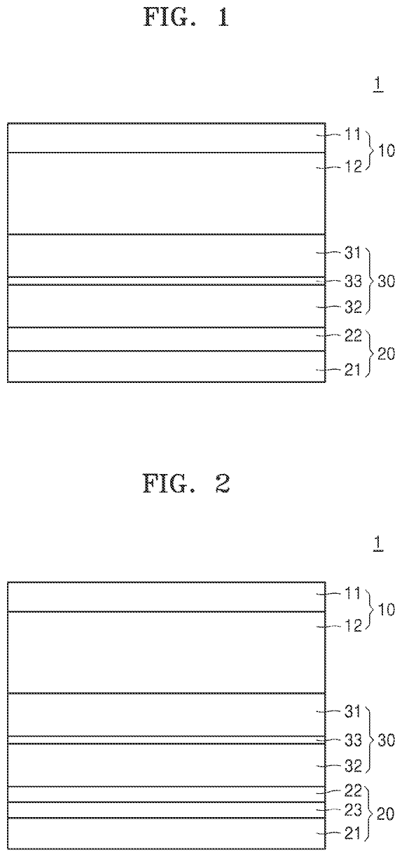

Referring to FIG. 2, the sodium all-solid secondary battery 1 may further include, for example, a metal layer 23 disposed between the anode current collector 21 and the anode active material layer 22 after charging. The metal layer 23 is a metal layer including sodium metal or a sodium alloy. Therefore, the metal layer 23 may serve, for example, as a sodium reservoir. The sodium alloy may be, for example, a Na—Sn alloy, a Na—In alloy, a Na—Ag alloy, a Na—Au alloy, a Na—Zn alloy, a Na—Ge alloy, or a Na—Si alloy, but is not limited thereto, and any suitable sodium alloys available in the art may also be used. The metal layer 23 may comprise one of the alloys alone, sodium, or a combination of various types of alloys. The metal layer 23 may be, for example, a plated layer. For example, the metal layer 23 may be plated between the anode active material layer 22 and the anode current collector 21 during a charging and discharging process of the sodium all-solid secondary battery 1.

A thickness of the metal layer 23 is not limited, but may be, for example, from about 1 μm to about 500 μm, from about 1 μm to about 200 μm, from about 1 μm to about 150 μm, from about 1 μm to about 100 μm, or from about 1 μm to about 50 μm. When the metal layer 23 is too thin, a role of the metal layer 23 as a sodium reservoir may not be performed. When the metal layer 23 is too thick, the mass and volume of the sodium all-solid secondary battery 1 increases, and thus cycle characteristics of the sodium all-solid secondary battery 1 may deteriorate.

Alternatively, in the sodium all-solid secondary battery 1, the metal layer 23 may be disposed between the anode current collector 21 and the active material layer 22 before assembling the sodium all-solid secondary battery 1. When the metal layer 23 is disposed between the anode current collector 21 and the anode active material layer 22 before assembling the sodium all-solid secondary battery 1, the metal layer 23, as a metal layer including sodium, may serve as a reservoir of sodium. For example, before assembling the sodium all-solid secondary battery 1, a sodium foil may be disposed between the anode current collector 21 and the anode active material layer 22.

When the metal layer 23 is plated by charging after assembling the sodium all-solid secondary battery 1, energy density of the sodium all-solid secondary battery 1 may increase because the metal layer 23 is not included while the sodium all-solid secondary battery 1 is assembled. While the sodium all-solid secondary battery 1 is charged, charging may be performed to exceed a charge capacity of the anode active material layer 22. That is, the anode active material layer 22 is overcharged. During initial charging, sodium is absorbed to the anode active material layer 22. The anode active material included in the anode active material layer 22 may form an alloy or compound with sodium ions that have migrated from the cathode 10. When the anode active material layer 22 is overcharged to exceed the capacity thereof, sodium may be plated on a rear surface of the anode active material layer 22, i.e., between the anode current collector 21 and the anode active material layer 22, and the metal layer 23 may be formed by the plated sodium. The metal layer 23 is a metal layer mainly comprising sodium (i.e., sodium metal). This result is obtained because the anode active material included in the anode active material layer 22 includes a material forming an alloy or compound with sodium. During discharging, sodium of the anode active material layer 22 and the metal layer 23, i.e., sodium of the metal layer, may be ionized to migrate in a direction toward the cathode 10. Sodium may be used as an anode active material in the sodium all-solid secondary battery 1. In addition, because the metal layer 23 is coated with the anode active material layer 22, the anode active material layer 22 serves as a protective layer for the metal layer, as well as, preventing precipitation and growth of sodium dendrite. A short circuit and capacity reduction may be inhibited in the sodium all-solid secondary battery 1, and thus cycle characteristics of the sodium all-solid secondary battery 1 may be improved. When the metal layer 23 is disposed by charging after assembling the sodium all-solid secondary battery 1, the anode 20, i.e., the anode current collector 21, the anode active material layer 22, and a region therebetween, may be a Na-free region not including sodium (Na) in the early stage of charging or after completely discharging the sodium all-solid secondary battery 1.

### [Anode I: Anode Current Collector]

The anode current collector 21 may comprise, for example, a material that does not react with sodium, i.e., a material that does not form an alloy or compound with sodium. The material of the anode current collector 21 may be, for example, indium (In), copper (Cu), stainless steel, titanium (Ti), iron (Fe), cobalt (Co), or nickel (Ni), but is not limited thereto, and any suitable materials commonly available in the art as electrode current collectors may also be used. The anode current collector 21 may be formed of one metal selected from those described above or an alloy or coating material of two or more metals selected therefrom. The anode current collector 21 may be, for example, in the form of a plate or foil.

The sodium all-solid secondary battery 1 may further include, for example, a thin film (e.g., film) including a fourth metal capable of forming an alloy with sodium between the anode current collector 21 and the anode active material layer 22 although not shown in the drawings. The thin film may be, for example, disposed on a side of the anode current collector 21. The fourth metal may include, for example, gold (Au), tin (Sn), titanium (Ti), zinc (Zn), platinum (Pt), silicon (Si), silver (Ag), bismuth (Bi), germanium (Ge), lead (Pb), antimony (Sb), or a combination thereof, but is not limited thereto, and any suitable materials used in the art as an element forming an alloy with sodium may also be used. The thin film may be formed of any one of the metals or an alloy of various types of metals. By disposing the thin film between the anode current collector 21 and the anode active material layer 22, the metal layer 23 plated between the thin film 23 and the anode active material layer 22 may become flatter, thereby further improving cycle characteristics of the sodium all-solid secondary battery 1.

For example, the thin film may have a thickness of about 1 nm to about 800 nm, about 10 nm to about 700 nm, about 50 nm to about 600 nm, or about 100 nm to about 500 nm. When the thickness of the thin film is less than 1 nm, the function of the thin film may be difficult to obtain. When the thin film is too thick, the thin film absorbs sodium and an amount of plated sodium in the anode decreases, and thus energy density of the sodium all-solid secondary battery 1 may decrease and cycle characteristics of the sodium all-solid secondary battery 1 may deteriorate. The thin film may be formed on the anode current collector 21, for example, by vacuum deposition, sputtering, or plating. However, the method is not limited thereto and any suitable method capable of forming a thin film and commonly used in the art may also be used.

The anode current collector 21 may include, for example, a base film and a metal layer disposed on one or both sides of the base film. The base film may include, for example, a polymer. The polymer may include, for example, polyethyleneterephthalate (PET), polyethylene (PE), polypropylene (PP), polybutyleneterephthalate (PBT), polyimide (PI), or any combination thereof. The metal layer may include, for example, indium (In), copper (Cu), stainless steel, titanium (Ti), iron (Fe), cobalt (Co), nickel (Ni), or an alloy thereof. If the anode current collector 21 has the above-described structure, the weight of the anode may be reduced, so that energy density of the all-solid secondary battery may be increased.

### [Anode I: Anodeless (e.g., not Including an Anode Active Material Layer)]

Referring to FIG. 6, the anode 20 includes only the anode current collector 21 and the anode active material layer may be omitted. An anode active material layer is plated between the electrolyte 30 and the anode current collector 21 by charging the sodium all-solid secondary battery 1. The anode active material layer may be, for example, a sodium metal layer or a sodium alloy layer. After charging, the sodium all-solid secondary battery 1 includes, for example, the anode active material layer 22 as shown in FIG. 1, and the anode active material layer is the above-described sodium metal layer or sodium alloy layer.

Energy density of the sodium all-solid secondary battery 1 may further be increased because the anode 20 includes only the anode current collector 21.

### [Anode II: Non-plated Anode]

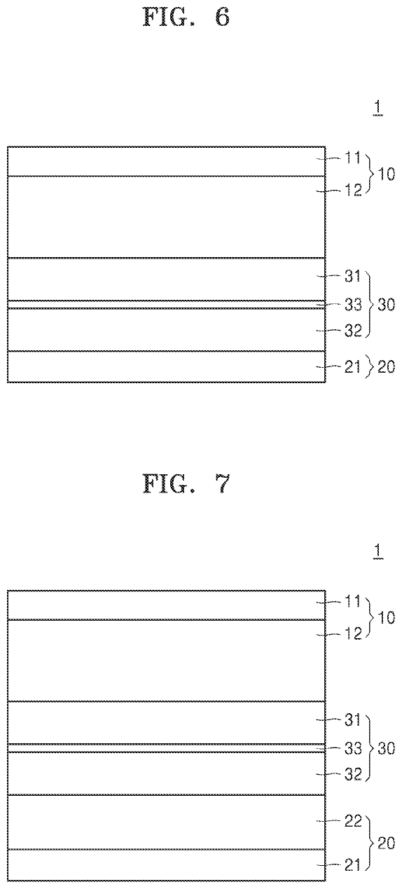

Referring to FIG. 7, the anode 20 may be a non-plated anode 20. In the non-plated anode 20, sodium is absorbed to the anode active material layer of the all-solid secondary battery by charging, and a sodium metal layer may not be additionally plated between the anode active material layer and the anode current collector. In the all-solid secondary battery 1 including the non-plated anode 20, a volume change is reduced in the anode 20 during charging and discharging, and thus lifespan characteristics of the all-solid secondary battery 1 may further be improved.

### [Anode II: Anode Active Material]

Referring to FIG. 7, the anode active material layer 22 may include an anode active material, a conductive material, and a binder.

Amounts of the anode active material, conductive material, and binder used in the anode active material layer 22 may be suitable levels used in sodium all-solid secondary batteries 1. At least one of the conductive material and the binder may be omitted according to the desired use and configuration of the sodium all-solid secondary battery 1.

The anode active material may include, for example, a metal anode active material such as Na metal, Sn metal, Bi metal, Zn metal, a Sn—Cu alloy, and a Bi—Cu alloy; a carbonaceous anode active material such as hard carbon and soft carbon; an oxide-based anode active material including Ti and/or Nb; or any combination thereof, but is not limited thereto, and any suitable anode active materials used in the art may also be used.

The oxide-based anode active material including Ti and/or Nb is highly safe. For example, an oxide-based anode active material including a crystal phase represented by Na₄TiO(PO₄)₂ and Na₅Ti(PO₄)₃ and having an oxidation-reduction potential of 1.5 V (vs. Na/Na⁺) or less involved in charging and discharging may be used.

An amount of the anode active material may be about 50 wt % to about 99 wt % or about 60 wt % to about 90 wt % of a total weight of the anode active material layer 22.

### [Anode II: Binder]

The binder included in the anode active material layer 22 may be selected from the above-described binders used in the plated anode.

The binder may be, for example, a vinylidene fluoride/hexafluoropropylene copolymer, polyvinylidene fluoride, polyacrylonitrile, polymethylmethacrylate, polytetrafluoroethylene (PTFE), a mixture thereof, a styrene butadiene rubber polymer, polyacrylic acid, polyacrylic acid substituted with sodium, polyamideimide, or polyimide, but is not limited to, and any suitable material used in the art may also be used.

An amount of the binder may be from about 0.1 to about 10 wt % or from about 0.1 to about 5 wt % based on the total weight of the anode active material layer 22.

### [Anode II: Conductive Material]

The anode active material layer 22 may further include a conductive material. The conductive material may include a fibrous conductive material, a particulate conductive material, or any combination thereof. The conductive material may be, for example, graphite, carbon black, acetylene black, Ketjen black, carbon fiber, carbon nanotube, carbon nanofiber, or metal powder, but is not limited thereto, and any suitable conductive materials available in the art may also be used. The conductive material may be omitted.

An amount of the conductive material may be, for example, from about 0.1 wt % to about 10 wt % or from about 0.1 wt % to about 5 wt % based on the total weight of the anode active material layer 22.

### [Anode II: Other Additives]

The anode active material layer 22 may further include additives used in sodium all-solid secondary batteries 1, such as a filler, a coating agent, a dispersant, and an ion-conductive adjuvant.

### [Anode II: Anode Active Material Layer]

A ratio B/A of an initial charge capacity B of the anode active material layer 22 to an initial charge capacity A of the cathode active material layer may be about 1 or greater. The initial charge capacity of the cathode active material layer 12 and the initial charge capacity of the anode active material layer 22 may be measured by the same method used in the above-described plated anode. The ratio B/A of the initial charge capacity B of the anode active material layer 22 to the initial charge capacity A of the cathode active material layer may be, for example, from about 1.0 to about 1.3, from about 1.0 to about 1.2, from about 1.0 to about 1.1, or from about 1.01 to about 1.1. The initial charge capacity B of the anode active material layer 22 may be, for example, greater than the initial charge capacity A of the cathode active material layer. Plating of sodium metal may be inhibited and the growth of sodium dendrite may be inhibited when the initial charge capacity B of the anode active material layer 22 is greater than the initial charge capacity A of the cathode active material layer.

### [Anode II: Anode Current Collector]

The anode current collector 21 may be selected from the above-described anode current collectors used in the plated anode 20.

### [Sodium All-solid Secondary Battery: Bi-cell Structure]

Although not shown in the drawings, the sodium all-solid secondary battery may have a bi-cell structure including two anodes corresponding to both sides of one cathode or including two cathodes corresponding to both sides of one anode.

In the sodium all-solid secondary battery, the anode may include, for example, a first anode disposed on a first side of the cathode and a second anode disposed on a second side, opposite to the first side of the cathode. The electrolyte may include, for example, a first electrolyte disposed between the cathode and the first anode and a second electrolyte disposed between the cathode and the second anode. The sodium all-solid secondary battery may have a structure in which the first anode, the first electrolyte, the cathode, the second electrolyte, and the second anode are sequentially disposed (e.g., arranged). The first electrolyte may sequentially include, for example, an oxide-based electrolyte, a bonding layer, and a sulfide-based electrolyte. The second electrolyte may sequentially include, for example, a sulfide-based electrolyte, a bonding layer, and an oxide-based electrolyte. The bonding layer may include a metal capable of forming an alloy with sodium, a sodium ion-conductive material, or any combination thereof. For more descriptions of materials of the sulfide-based electrolyte, the oxide-based electrolyte, and the bonding layer, refer to the above-described sodium all-solid secondary battery. Since the sodium all-solid secondary battery has such a bi-cell structure, cracks may be inhibited in the cathode and/or the anode during a pressing process of a manufacturing process and a volume change of the cathode may be more effectively accommodated during charging and discharging. Cycle characteristics of the sodium all-solid secondary battery may be improved.

In the sodium all-solid secondary battery, the cathode may include a first cathode disposed on a first side of the anode and a second cathode disposed on a second side, opposite to the first side of the anode. The electrolyte may include, for example, a third electrolyte disposed between the anode and the first cathode and a fourth electrolyte disposed between the anode and the second cathode. The sodium all-solid secondary battery may have a structure in which the first cathode, the third electrolyte, the anode, the fourth electrolyte, and the second cathode are sequentially arranged. The third electrolyte may sequentially include, for example, a sulfide-based electrolyte, a bonding layer, and an oxide-based electrolyte. The fourth electrolyte may sequentially include, for example, an oxide-based electrolyte, a bonding layer, and a sulfide-based electrolyte. The bonding layer may include a metal capable of forming an alloy with sodium, a sodium ion-conductive material, or any combination thereof. For more descriptions of materials for the sulfide-based electrolyte, the oxide-based electrolyte, and the bonding layer, refer to the above-described sodium all-solid secondary battery. Since the sodium all-solid secondary battery has such a bi-cell structure, cracks may be inhibited in the anode and/or the cathode during a pressing process of a manufacturing process and a volume change of the anode may be more effectively accommodated during charging and discharging. Cycle characteristics of the sodium all-solid secondary battery may be improved.

Hereinafter, one or more embodiments will be described in more detail with reference to the following examples and comparative examples. However, these examples are not intended to limit the purpose and scope of the one or more embodiments.

### EXAMPLES

### Example 1: [Anode Current Collector (In)/Bonding Layer (Au)/Oxide-based Solid Electrolyte Layer (NASICON)/Bonding Layer (Au)/Sulfide-based Solid Electrolyte Layer (Na₃₋ₓPS₄₋ₓClₓ (wherein x=0.0625))/Cathode Active Material Layer (Na₃V₂(PO₄)₃)/Cathode Current Collector (SUS)]

### (Preparation of Cathode)

Na₃V₂(PO₄)₃ was prepared as a cathode active material. Na₃₋ₓPS₄₋ₓClₓ (wherein x=0.0625) was prepared as a sulfide-based solid electrolyte. Carbon nanotubes were prepared as a conductive material.

The cathode active material, the solid electrolyte, and the conductive material were mixed in a weight ratio of 60:35:5 to prepare a cathode mixture. The cathode mixture was obtained by dry mixing using a ball mill. The cathode mixture obtained by ball milling formed an ion-conductive and electron-conductive network. The cathode mixture was disposed on one side of a 20 μm-thick SUS cathode current collector and plate pressed to prepare a cathode. The cathode has a thickness of 30 μm.

(Preparation of Anode, Solid Electrolyte Layer, and Sodium all-Solid Secondary Battery)

Na₃₋ₓPS₄₋ₓClₓ (wherein x=0.0625) was prepared as a sulfide-based solid electrolyte to prepare a sulfide-based electrolyte. The sulfide-based solid electrolyte powder was prepared.

900 μm Na₃Zr₂Si₂PO₁₂ pellets having a NASICON structure were prepared as an oxide-based electrolyte.

A gold (Au) first metal layer having a thickness of about 30 nm and an Au second metal layer having a thickness of about 30 nm were formed by sputtering respectively on a first side of Na₃Zr₂Si₂PO₁₂ pellets arranged to be adjacent to the sulfide-based electrolyte and a second side thereof opposite to the first side. The first metal layer and the second metal layer correspond to bonding layers.

An indium (In) foil having a thickness of 20 μm was prepared as an anode current collector.

The In foil was located on the bottom of a torque cell, and the Na₃Zr₂Si₂PO₁₂ pellets were located thereon such that the first metal layer was located on the In foil. Powder of the sulfide-based solid electrolyte was supplied onto the second metal layer of the Na₃Zr₂Si₂PO₁₂ pellets to arrange the sulfide-based solid electrolyte layer. The cathode was located on the central region of the surface of the sulfide-based solid electrolyte layer such that the cathode active material layer is in contact with the sulfide-based solid electrolyte layer. Peripheral areas of the cathode are spaced apart from peripheral areas of the sulfide-based solid electrolyte layer. The powder of the sulfide-based solid electrolyte was additionally applied to side surfaces of the cathode to embed the cathode in the sulfide-based solid electrolyte layer. The SUS cathode current collector of the cathode was exposed on the surface of the sulfide-based solid electrolyte layer. The sulfide-based solid electrolyte disposed on the side surfaces of the cathode corresponds to a gasket that is an inert member. By pressing the torque cell while assembling, a sodium all-solid secondary battery was assembled. By locating the inert member on the side surfaces of the cathode, a short circuit between the cathode and the anode may be prevented while assembling the torque cell. By such pressing treatment, the sulfide-based solid electrolyte layer was sintered to improve battery characteristics.

The sulfide-based solid electrolyte, as the sulfide-based electrolyte, had a thickness of 500 μm. The thickness of the sulfide-based solid electrolyte layer, i.e., inert member, arranged on side surfaces of the cathode was identical to the thickness of the cathode.

The sodium all-solid secondary battery had an [anode current collector (In)/bonding layer (Au)/oxide-based solid electrolyte layer (NASICON)/bonding layer (Au)/sulfide-based solid electrolyte layer (Na₃₋ₓPS₄₋ₓClₓ (wherein x=0.0625))/cathode active material layer (Na₃V₂(PO₄)₃)/cathode current collector (SUS)] structure.

### Example 2: [Anode Current Collector (In)/Anode Active Material Layer (Ag—C)/Bonding Layer (Au)/Oxide-based Solid Electrolyte Layer (NASICON)/Bonding Layer (Au)/Sulfide-based Solid Electrolyte Layer (Na_{2.9}P_{0.9}W_{0.1}S₄))/Cathode Active Material Layer (Na₃V₂(PO₄)₃)/Cathode Current Collector (SUS)]

### (Preparation of Cathode)

A cathode was prepared in the same manner as in Example 1, except that an indium (In) foil was used as the cathode current collector instead of SUS and Na_{2.9}P_{0.9}W_{0.1}S₄ was used as the sulfide-based solid electrolyte instead of Na₃₋ₓPS₄₋ₓClₓ (wherein x=0.0625).

(Preparation of Sodium all-Solid Secondary Battery)

Na_{2.9}P_{0.9}W_{0.1}S₄ was prepared as a sulfide-based solid electrolyte to prepare a sulfide-based electrolyte. The sulfide-based solid electrolyte powder was prepared.

Na₃Zr₂Si₂PO₁₂ pellets used in Example 1 were prepared as an oxide-based electrolyte.

A gold (Au) first metal layer having a thickness of about 30 nm and a Au second metal layer having a thickness of about 30 nm were formed by sputtering respectively on a first side of Na₃Zr₂Si₂PO₁₂ pellets arranged to be adjacent to the sulfide-based electrolyte and a second side thereof opposite to the first side. The first metal layer and the second metal layer correspond to bonding layers.

An SUS sheet having a thickness of 20 μm was prepared as an anode current collector. Carbon black (CB) with a primary particle diameter of about 30 nm and silver (Ag) particles with an average particle diameter of about 60 nm were prepared as anode active materials.

4 g of mixed powder of the carbon black (CB) and silver (Ag) particles in a weight ratio of 3:1 was added to a container, and 4 g of a N-methyl-2-pyrrolidone (NMP) solution including 7 wt % of a PVDF binder (#9300 manufactured by Kureha Corporation) was added thereto to prepare a mixed solution. Subsequently, NMP was gradually added to the mixed solution while stirring the mixed solution to prepare a slurry. The prepared slurry was applied to the SUS cathode current collector using a bar coater and dried in the air at 80° C. for 10 minutes. A stack structure obtained thereby was dried at 40° C. for 10 hours in a vacuum. The dried stack structure was cold rolled by a cold roll press at a pressure of 5 ton-force per square centimeter (ton-f/cm²) at a speed of 5 meters per second (m/sec) to planarize the surface of the anode active material layer of the stack structure.

A sodium all-solid secondary battery was prepared in the same manner as in Example 1, except that the stack structure was located on the bottom of a torque cell, and Na₃Zr₂Si₂PO₁₂ pellets were located thereon such that the first metal layer was located on the anode active material layer of the stack structure.

The sodium all-solid secondary battery had an [anode current collector (SUS)/anode active material layer (Ag—C)/bonding layer (Au)/oxide-based solid electrolyte layer (NASICON)/bonding layer (Au)/sulfide-based solid electrolyte layer (Na_{2.9}P_{0.9}W_{0.1}S₄)/cathode active material layer (Na₃V₂(PO₄)₃)/cathode current collector (SUS)] structure.

### Comparative Example 1: [Anode Current Collector (in)/Bonding Layer (Au)/Oxide-Based Solid Electrolyte Layer (NASICON)/Bonding Layer (Au)/Cathode Active Material Layer (Na₃V₂(PO₄)₃)/Cathode Current Collector (SUS)]

A sodium all-solid secondary battery was prepared in the same manner as in Example 1, except that the sulfide-based solid electrolyte layer was not used.

### Comparative Example 2: [Anode Current Collector (in)/Sulfide-Based Solid Electrolyte Layer (Na₃₋ₓPS₄₋ₓClₓ (Wherein x=0.0625))/Cathode Active Material Layer (Na₃V₂(PO₄)₃)/Cathode Current Collector (SUS)]

A sodium all-solid secondary battery was prepared in the same manner as in Example 1, except that the oxide-based solid electrolyte layer was not used.

### Comparative Example 3: [Anode Current Collector (in)/Oxide-Based Solid Electrolyte Layer (NASICON)/Sulfide-Based Solid Electrolyte Layer (Na₃₋ₓPS₄₋ₓClₓ (Wherein x=0.0625))/Cathode Active Material Layer (Na₃V₂(PO₄)₃)/Cathode Current Collector (in)]

A sodium all-solid secondary battery was prepared in the same manner as in Example 1, except that the bonding layer was not used and an In foil was used as the cathode current collector.

### Comparative Example 4: [Anode Current Collector (SUS)/Anode Active Material Layer (Ag—C)/Bonding Layer (Au)/Oxide-Based Solid Electrolyte Layer (NASICON)/Bonding Layer (Au)/Oxide-Based Solid Electrolyte Layer (NASICON))/Bonding Layer (Au)/Cathode Active Material Layer (Na₃V₂(PO₄)₃)/Cathode Current Collector (in)]

A sodium all-solid secondary battery was prepared in the same manner as in Example 2, except that an oxide-based solid electrolyte sheet same as the oxide-based solid electrolyte layer was used instead of the sulfide-based solid electrolyte layer.

An oxide-based solid electrolyte sheet having a 30 nm-thick Au metal layer formed on one side adjacent to the cathode active material layer was used.

### Comparative Example 5: [Anode Current Collector (SUS)/Sulfide-Based Solid Electrolyte Layer (Na₃₋ₓPS₄₋ₓClₓ (Wherein x=0.0625))/Bonding Layer (in)/Sulfide-Based Solid Electrolyte Layer (Na₃₋ₓPS₄₋ₓClₓ (Wherein x=0.0625))/Cathode Active Material Layer (Na₃V₂(PO₄)₃)/Cathode Current Collector (in)]

A sodium all-solid secondary battery was prepared in the same manner as in Example 1, except that the sulfide-based solid electrolyte layer was used instead of the oxide-based solid electrolyte layer, an SUS sheet was used as the anode current collector, an In foil was used as the cathode current collector, and In was used as the bonding layer. The bonding layer has a thickness of 30 nm.

### Comparative Example 6: [Anode Current Collector (SUS)/Sulfide-Based Solid Electrolyte Layer (Na₃₋ₓPS₄₋ₓClₓ (Wherein x=0.0625))/Bonding Layer (Sn)/Oxide-Based Solid Electrolyte Layer (NASICON)/Bonding Layer (Sn)/Cathode Active Material Layer (Na₃V₂(PO₄)₃)/Cathode Current Collector (in)]

A sodium all-solid secondary battery was prepared in the same manner as in Example 1, except that the positions of the oxide-based solid electrolyte layer and the sulfide-based solid electrolyte layer were reversed, the positions of the cathode current collector and the anode current collector were reversed, and Au of the bonding layer disposed between the oxide-based solid electrolyte layer and the sulfide-based solid electrolyte layer was replaced with Sn. The bonding layer has a thickness of 30 nm.

### Example 3: [Anode Current Collector (Cu)/Metal Layer (Na)/Bonding Layer (Sn, 10 Nm)/Oxide-Based Solid Electrolyte Layer (NASICON)/Bonding Layer (Sn, 10 nm)/Counter Electrode Active Material Layer (Carbon Black)/Counter Electrode Current Collector (SUS)]

### (Preparation of Counter Electrode Layer)

An SUS sheet having a thickness of 20 μm was prepared as an electrode current collector. Carbon black (CB) particles with a primary particle diameter of about 30 nm were prepared as an electrode active material.

4 g of mixed powder of the carbon black (CB 25) was added to a container, and 4 g of a NMP solution including 7 wt % of a PVDF binder (#9300 manufactured by Kureha Corporation) was added thereto to prepare a mixed solution. Subsequently, NMP was gradually added to the mixed solution while stirring the mixed solution to prepare a slurry. The prepared slurry was applied to the SUS electrode current collector using a bar coater and dried in the air at 80° C. for 10 minutes. A stack structure obtained thereby was dried at 40° C. for 10 hours in a vacuum. The dried stack structure was cold rolled by a cold roll press at a pressure of 5 ton-f/cm² at a speed of 5 m/see to planarize the surface of the mixed layer of the stack structure.

(Preparation of Anode, Solid Electrolyte Layer, and Sodium all-Solid Secondary Battery)

Na₃₋ₓPS₄₋ₓClₓ (wherein x=0.0625) was prepared as a sulfide-based solid electrolyte to prepare a sulfide-based electrolyte. Powder of the sulfide-based solid electrolyte was prepared.

900 μm Na₃Zr₂Si₂PO₁₂ pellets having a NASICON structure were prepared as an oxide-based electrolyte.

Na₃Zr₂Si₂PO₁₂ pellets used in Example 1 was prepared as an oxide-based electrolyte.

A tin (Sn) first metal layer having a thickness of about 10 nm and a Sn second metal layer having a thickness of about 10 nm were formed by sputtering respectively on a first side of Na₃Zr₂Si₂PO₁₂ pellets arranged to be adjacent to the sulfide-based electrolyte and a second side thereof opposite to the first side. The first metal layer and the second metal layer correspond to bonding layers.

A copper (Cu) foil having a thickness of 20 μm was prepared as an anode current collector. A sodium (Na) metal layer having a thickness of 50 μm, as a metal layer, was located on the anode current collector to prepare a stack structure.

The stack structure was located on the bottom of a torque cell, and Na₃Zr₂Si₂PO₁₂ pellets were located thereon such that the first metal layer was located on the sodium metal layer of the stack structure. A counter electrode was located on the second metal layer of the Na₃Zr₂Si₂PO₁₂ pellets. By pressing the torque cell while assembling, a sodium all-solid secondary battery was prepared.

The sodium all-solid secondary battery had an [anode current collector (Cu)/metal layer (Na)/bonding layer (Sn)/oxide-based solid electrolyte layer (NASICON)/bonding layer (Sn)/counter electrode active material layer (carbon black)/counter electrode current collector (SUS)] structure.

### Example 4: [Anode Current Collector (Cu)/Metal Layer (Na)/Bonding Layer (Sn, 40 nm)/Oxide-Based Solid Electrolyte Layer (NASICON)/Bonding Layer (Sn, 40 nm)/Counter Electrode Active Material Layer (Carbon Black)/Counter Electrode Current Collector (SUS)]

A sodium all-solid secondary battery was prepared in the same manner as in Example 3, except that the thicknesses of the first metal layer and the second metal layer were 40 nm, respectively.

### Reference Example 1: [Anode Current Collector (Cu)/Metal Layer (Na)/Bonding Layer (Sn, 150 nm)/Oxide-Based Solid Electrolyte Layer (NASICON)/Bonding Layer (Sn, 150 Nm)/Counter Electrode Active Material Layer (Carbon Black)/Counter Electrode Current Collector (SUS)]

A sodium all-solid secondary battery was prepared in the same manner as in Example 3, except that the thicknesses of the first metal layer and the second metal layer were 150 nm, respectively.

### Evaluation Example 1: Charging/Discharging Characteristics Test I

Charging and discharging characteristics of each of the sodium all-solid secondary batteries prepared in Examples 1 to 2 and Comparative Examples 1 to 6 were evaluated by the following charging/discharging test. The charging and discharging test was performed by placing the sodium all-solid secondary battery in a thermostatic bath at 60° C.

Charging and discharging were performed under the conditions that the battery was charged at a constant current of 0.02 mA/cm² until a battery voltage reached 4 V and discharged at a constant current of 0.02 mA/cm² until the battery voltage reached 2.25 V.

The charging and discharging conditions were partially modified in some examples and comparative examples.

For the sodium all-solid secondary battery of Example 1, the charging process was cut-off at a charging capacity of 0.2 mAh in a first cycle. Subsequently, the battery was discharged at a constant current of 0.02 mA/cm² until the battery voltage reached 2.25 V.

The cycle was repeated twice. A discharging capacity of the first cycle was 1.7 mAh. An initial charge/discharge efficiency of the first cycle was about 85%.

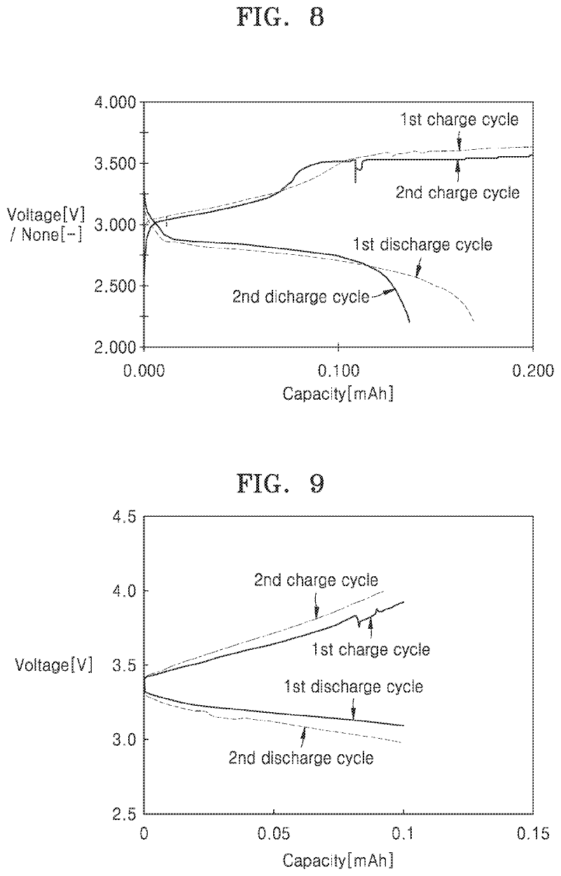

Charging/discharging profiles of first and second cycles of the sodium all-solid secondary battery of Example 1 are shown in FIG. 8.

The sodium all-solid secondary battery of Example 2 was charged until a charging capacity of a first cycle reached 0.1 mAh. Subsequently, the battery was discharged at a constant current of 0.02 mA/cm² until a discharging capacity reached 0.1 mAh.

The cycle was repeated twice. Charging/discharging profiles of first and second cycles of the sodium all-solid secondary battery of Example 2 are shown in FIG. 9.

Charging could be performed but discharging could not be performed in the sodium all-solid secondary batteries of Comparative Examples 1 to 3 and 5.

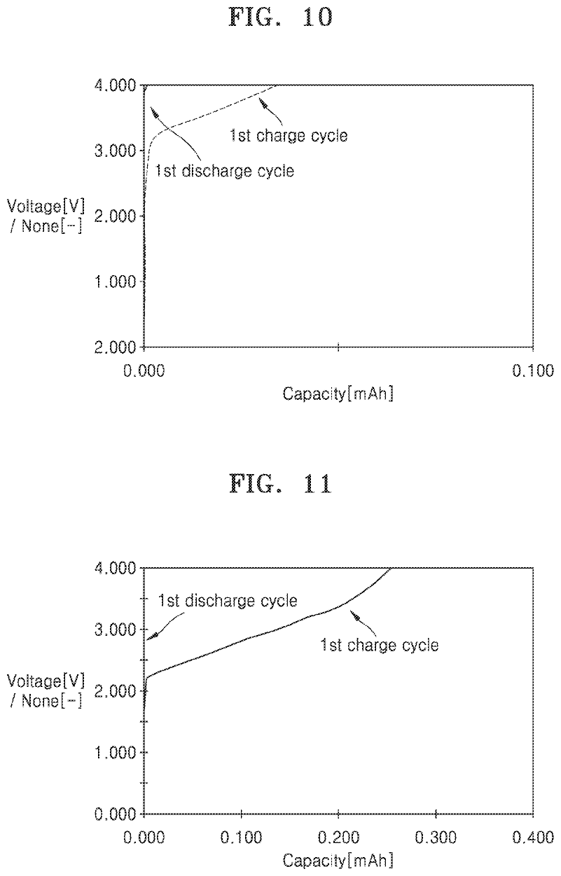

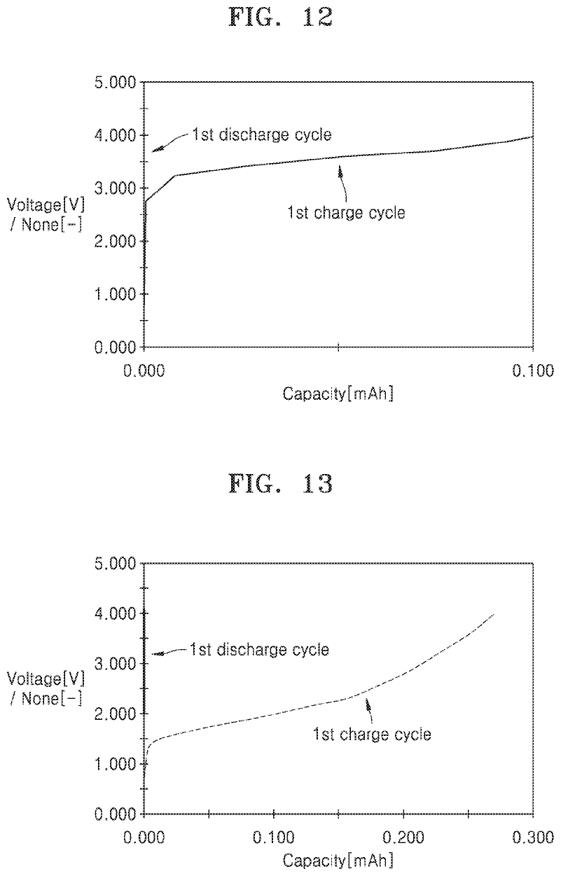

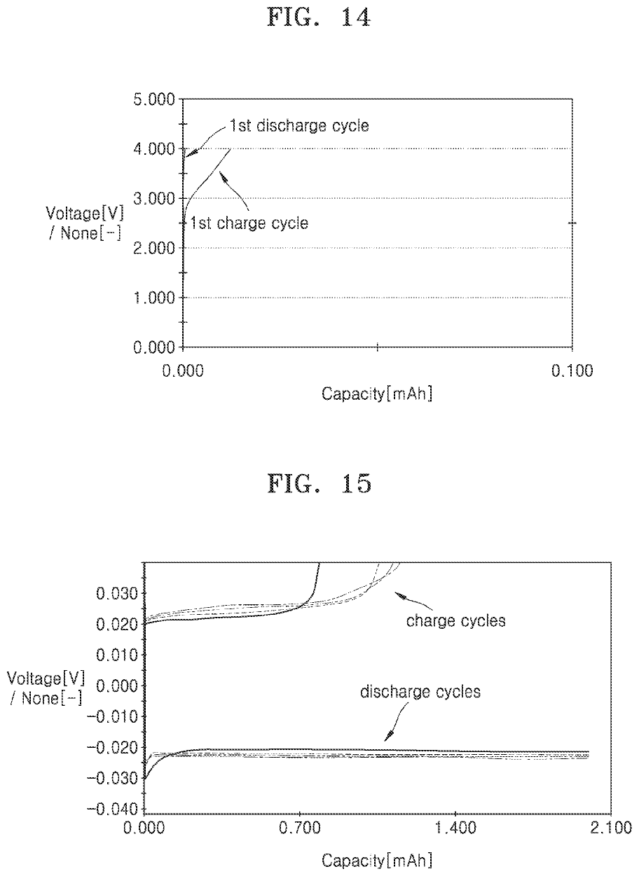

Charging/discharging profiles of the sodium all-solid secondary batteries of Comparative Examples 1 to 3, 5, and 6 are shown respectively in FIGS. 10 to 14.

Charging and discharging could not be performed in the sodium all-solid secondary battery of Comparative Example 4.

### Evaluation Example 2: Charging/discharging Characteristics Test II

Charging and discharging characteristics of each of the sodium all-solid secondary batteries prepared in Examples 3 to 4 and Reference Example 1 were evaluated by the following charging/discharging test. The charging and discharging test was performed by placing the sodium all-solid secondary battery in a thermostatic bath at 60° C.

The sodium all-solid secondary batteries of Examples 3 and 4 and Reference Example 1 were charged at a constant current of 0.02 mA/cm² up to a charging capacity of 1.0 mAh and discharged under the same constant current conditions.

Charging/discharging profiles of the sodium all-solid secondary batteries of Examples 3 and 4 and Reference Example 1 are shown in FIGS. 15 to 17.

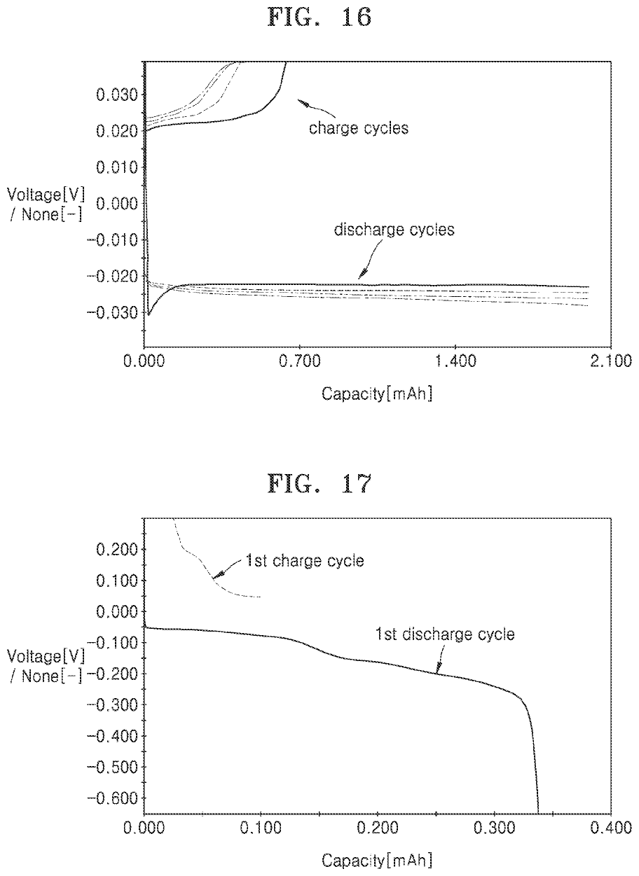

As shown in FIGS. 15 and 16, the charging and discharging profiles of the sodium all-solid secondary batteries of Examples 3 and 4 were stable.

As shown in FIG. 17, the charging and discharging profile of the sodium all-solid secondary battery of Reference Example 1 were unstable.

As described above, the sodium all-solid secondary battery according to an embodiment may be applied to various types of portable devices and vehicles.

Although embodiments are described above with reference to illustrated drawing, the present inventive concept is not limited thereto. It is obvious that various alternations and modifications will be apparent to one or ordinary skill in the art to which this application belongs within protection coverage of the inventive concept.

According to the sodium all-solid secondary battery having a structure according to an embodiment, a sodium all-solid secondary battery having improved cycle characteristics may be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A sodium all-solid secondary battery comprising:
a cathode;
an anode;
a sulfide-containing electrolyte between the cathode and the anode;
an oxide-containing electrolyte between the sulfide-containing electrolyte and the anode; and
a first bonding layer between the oxide-containing electrolyte and the sulfide-containing electrolyte,
wherein the cathode comprises a cathode current collector and a cathode active material layer, the anode comprises an anode current collector and an anode active material layer, and
the first bonding layer comprises a metal capable of forming an alloy with sodium, a sodium ion-conductive material, or a combination thereof.

2. The sodium all-solid secondary battery of claim 1, wherein the metal capable of forming an alloy with sodium comprises a first metal, and
the first metal comprises gold, tin, titanium, zinc, platinum, silicon, silver, bismuth, germanium, lead, antimony, or a combination thereof.

3. The sodium all-solid secondary battery of claim 1, wherein a thickness of the first bonding layer is less than a thickness of the sulfide-containing solid electrolyte, a thickness of the oxide-containing solid electrolyte, or both.

4. The sodium all-solid secondary battery of claim 1, wherein the first bonding layer has a Mohs hardness of less than about 4.

5. The sodium all-solid secondary battery of claim 1, wherein the sodium ion-conductive material comprises a solid electrolyte, a gel electrolyte, a liquid electrolyte, an ionic liquid, or a combination thereof,
the solid electrolyte comprises a sulfide-containing solid electrolyte, an oxide-containing solid electrolyte, a polymer solid electrolyte, or a combination thereof, and
the gel electrolyte comprises a polymer gel electrolyte.

6. The sodium all-solid secondary battery of claim 1, wherein the sulfide-containing solid electrolyte comprises Na₃PS₄, Na₃₋ₓPS₄₋ₓClₓ wherein 0<x<3,
Na₃₋ₓP₁₋ₓWₓS₄ wherein 0≤x<1, Na₃PS₄₋ₓOₓ wherein 0<x<4, Na₃₋₂ₓCaₓPS₄ wherein 0<x<1.5, Na₃SbS₄, Na₃₋ₓSb₁₋ₓWₓS₄ wherein 0≤x<1, Na_{2.88}Sb_{0.88}W_{0.12}S₄₋ₓNaI wherein 0<x<1, Na₃WₓSiₓSb₁₋₂ₓS₄ wherein 0≤x<0.5, Na₃₋ₓSb₁₋ₓWₓS₄₋₃ₓO₃ₓ wherein 0≤x<1, Na₃SbS₄—Na₂WₓS₄I₆ₓ₋₄ wherein 0≤x<1, Na₂S—P₂S₅, Na₂S—P₂S₅—NaX wherein X is F, Cl, Br, I, or a combination thereof, Na₂S—P₂S₅—Na₂O, Na₂S—P₂S₅—Na₂O—NaI, Na₂S—SiS₂, Na₂S—SiS₂—NaI, Na₂S—SiS₂—NaBr, Na₂S—SiS₂—NaCl, Na₂S—SiS₂—B₂S₃—NaI, Na₂S—SiS₂—P₂S₅—NaI, Na₂S—B₂S₃, Na₂S—P₂S₅—ZₘSₙ, wherein 0<m≤10, 0<n≤10, and Z is Ge, Zn, Ga, or a combination thereof, Na₂S—GeS₂, Na₂S—SiS₂—Na₃PO₄, Na₂S—SiS₂-NaₚMO_{q} wherein 0<p≤10, 0<q≤10, and M is P, Si, Ge, B, Al, Ga, In, or a combination thereof, Na₇₋ₓPS₆₋ₓClₓ wherein 0≤x≤2, Na₇₋ₓPS₆₋ₓBrₓ wherein 0≤x≤2, Na₇₋ₓPS₆₋ₓIₓ wherein 0≤x≤2, Na₁₀MP₂S₁₂ wherein M is Ge, Si, Sₙ, or a combination thereof, or a combination thereof, and
the sulfide-containing solid electrolyte is crystalline, amorphous, glassy, or glass ceramic.

7. The sodium all-solid secondary battery of claim 1, wherein the oxide-containing solid electrolyte comprises NaₐM1_{b}M2_{c}O_{d}, wherein M1 is Al, Y, Yb, Nd, Nb, Ti, or Hf, M2 is Si or P, 1≤a≤6 1≤b≤3, 2≤c≤5, and 5≤d≤15, Na₁₊ₓZr₂SiₓP₃₋ₓO₁₂ wherein 0≤x≤3, NaₓM₂(PO₄)₃ wherein M is V or Ti, and 0≤x≤3, Na₃₊ₓLa_{(2/3-x)(1/3-2x)}TiO₃ wherein 0.04<x<0.16, Na₁₊ₓAlₓTi₂₋ₓ(PO₄)₃ wherein 0<x<2, Na₁₊ₓAlₓGe₂₋ₓ(PO₄)₃ wherein 0<x<2, Na_{1+x+y}AlₓTi₂₋ₓSi_{y}P_{3-y}O₁₂ wherein 0<x<2 and 0≤y<3, BaTiO₃, Pb(ZrₚTi₁₋ₚ)O₃ wherein 0≤p≤1, Pb₁₋ₓLaₓZr_{1-y}Ti_{y}O₃ wherein 0≤x<1 and 0≤y<1, Pb(Mg_{1/3}Nb_{2/3})O₃—PbTiO₃, Na₃PO₄, NaₓTi_{y}(PO₄)₃ wherein 0<x<2 and 0<y<3, NaₓAl_{y}Ti_{z}(PO₄)₃ wherein 0<x<2, 0<y<1, and 0<z<3, Na_{1+x+y}(AlₚGa₁₋ₚ)ₓ(Ti_{q}Ge_{1-q})₂₋ₓSi_{y}P_{3-y}O₁₂ wherein 0≤x≤1, 0≤y≤1, 0<p≤1, and 0<q≤1, NaₓLa_{y}TiO₃ wherein 0<x<2 and 0<y<3, Na₂O, NaOH, Na₂CO₃, NaAlO₂, Na₂O—Al₂O₃—SiO₂—P₂O₅—TiO₂—GeO₂, Na₃₊ₓLa₃M₂O₁₂ wherein M is Te, Nb or Zr, and 1≤x≤10, Na₇La₃Zr₂O₁₂, Na₃₊ₓLa₃Zr₂₋ₐMₐO₁₂, wherein M is Ga, W, Nb, Ta, or Al, 0<a<2, and 1≤x≤10, or a combination thereof, and
the oxide-containing solid electrolyte is crystalline, amorphous, glassy, or glass ceramic.

8. The sodium all-solid secondary battery of claim 1, wherein the cathode active material layer comprises a polyanionic compound represented by Formulae 1 to 5, a layered sodium transition metal oxide represented by Formulae 6 and 7, or a Prussian blue compound represented by Formula 8:
NaM1(XO₄) Formula 1
wherein in Formula 1,
M1 is manganese, iron, nickel, cobalt, chromium, copper, titanium, zinc, vanadium, zirconium, cerium, or a combination thereof, and
X is phosphorus, sulfur, silicon, or a combination thereof,
NaₓM2_{y}(XO₄)₃ Formula 2
wherein in Formula 2,
0<x≤3, 0<y≤2,
M2 is manganese, iron, nickel, cobalt, chromium, copper, titanium, zinc, vanadium, zirconium, cerium, or a combination thereof, and
X is phosphorus, sulfur, silicon, or a combination thereof,
NaₓM3_{y}(XO₄)Z_{z} Formula 3
wherein in Formula 3,
0<x≤3, 0<y≤2, 0<z≤1,
M3 is manganese, iron, nickel, cobalt, chromium, copper, titanium, zinc, vanadium, zirconium, cerium, or a combination thereof,
X is phosphorus, sulfur, silicon, or a combination thereof, and
Z is F, Cl, Br, I, or a combination thereof,
Naₓ(M4Oₐ)_{y}(XO₄)_{z}Zᵥ Formula 4
wherein in Formula 4,
0<x≤3, 0<y≤2, 0<z≤2, 0<v≤1, 0<a≤5,
M4 is manganese, iron, nickel, cobalt, chromium, copper, titanium, zinc, vanadium, zirconium, cerium, or a combination thereof,
X is phosphorus, sulfur, silicon, or a combination thereof, and
Z is F, Cl, Br, I, or a combination thereof,
NaₓM5_{y}(XO₄)_{z}(Z₂O₇)ᵥ Formula 5
wherein in Formula 5,
0<x≤4, 0<y≤3, 0≤z≤3, 0≤v≤2,
M5 is manganese, iron, nickel, cobalt, chromium, copper, titanium, zinc, vanadium, zirconium, cerium, or a combination thereof, and
X and Z are each independently phosphorus, sulfur, silicon, or a combination thereof,
NaₓM6O₂ Formula 6
wherein in Formula 6,
0<x≤1, and
M6 is titanium, vanadium, manganese, cobalt, nickel, iron, chromium, copper, or a combination thereof,
NaₐNi_{b}M7_{c}M8_{d}M9ₑM10_{f}O₂ Formula 7
wherein in Formula 7,
0.4≤a<1, 0<b<0.5, 0≤c<1, 0≤d<0.5, 0≤e<0.5, 0≤f<0.5, 0<c+e<1.5,
M7 is manganese, titanium, zirconium, or a combination thereof,
M8 is magnesium, calcium, copper, zinc, cobalt, or a combination thereof,
M9 is manganese, titanium, zirconium, or a combination thereof, and
M10 is aluminum, iron, cobalt, molybdenum, chromium, vanadium, scandium, yttrium, or a combination thereof, and
NaₓM11_{y}M12_{z}(CN)₆ Formula 8
wherein in Formula 8,
0<x≤2, 0<y≤1, 0<z≤1, and
M12 and M12 are each independently manganese, nickel, copper, cobalt, iron, zinc, vanadium, chromium, or a combination thereof.

9. The sodium all-solid secondary battery of claim 1, further comprising a second bonding layer between the cathode and the sulfide-containing electrolyte, wherein the second bonding layer comprises a second metal, and the second metal comprises gold, tin, titanium, zinc, platinum, silicon, silver, bismuth, germanium, lead, antimony, or a combination thereof.

10. The sodium all-solid secondary battery of claim 1, wherein the anode active material layer comprises an anode active material and a binder, and
the anode active material comprises a carbonaceous anode active material, a metallic anode active material, or a combination thereof.

11. The sodium all-solid secondary battery of claim 10, wherein the carbonaceous anode active material comprises amorphous carbon, crystalline carbon, porous carbon, or a combination thereof.

12. The sodium all-solid secondary battery of claim 10, wherein the metallic anode active material comprises gold, titanium, platinum, palladium, silicon, silver, aluminum, bismuth, tin, zinc, germanium, lead, antimony, or a combination thereof.

13. The sodium all-solid secondary battery of claim 10, wherein the anode active material comprises a mixture of a first particle comprising amorphous carbon and a second particle comprising a metal or metalloid, and
an amount of the second particle is from about 1 weight percent to about 60 weight percent, based on a total weight of the mixture.

14. The sodium all-solid secondary battery of claim 1, wherein the anode active material layer has a thickness greater than a thickness of the first bonding layer.

15. The sodium all-solid secondary battery of claim 1, further comprising a third bonding layer disposed between the anode and the oxide-containing electrolyte,
wherein the third bonding layer comprises a third metal, and the third metal comprises gold, tin, titanium, zinc, platinum, silicon, silver, bismuth, germanium, lead, antimony, or a combination thereof.

16. The sodium all-solid secondary battery of claim 1, further comprising a metal layer between the anode current collector and the anode active material layer, and
the metal layer comprises sodium metal or a sodium alloy.

17. The sodium all-solid secondary battery of claim 1, further comprising a film comprising a fourth metal between the anode current collector and the anode active material layer, and
the fourth metal comprises gold, tin, titanium, zinc, platinum, silicon, silver, bismuth, germanium, lead, antimony, or a combination thereof.

18. The sodium all-solid secondary battery of claim 1, wherein the anode optionally comprises a first anode disposed on a first side of the cathode and a second anode disposed on a second side, opposite to the first side of the cathode, and
a first electrolyte is disposed between the cathode and the first anode, and a second electrolyte is disposed between the cathode and the second anode.

19. The sodium all-solid secondary battery of claim 1, wherein the cathode optionally comprises a first cathode disposed on a first side of the cathode and a second cathode disposed on a second side, opposite to the first side of the cathode, and
a third electrolyte disposed between the anode and the first cathode and a fourth electrolyte disposed between the anode and the second cathode.

20. A sodium all-solid secondary battery comprising:
a cathode;
an anode;
a sulfide-containing electrolyte between the cathode and the anode;
an oxide-containing electrolyte between the sulfide-containing electrolyte and the anode; and
a first bonding layer between the oxide-containing electrolyte and the sulfide-containing electrolyte,
wherein the cathode comprises a cathode current collector and a cathode active material layer, the anode comprises an anode current collector, and
the first bonding layer comprises a metal capable of forming an alloy with sodium, a sodium ion-conductive material, or a combination thereof.
